(19) United States
(12) Patent Application Publication
(10) Pub. No.: US 2026/0229762 A1
(43) Pub. Date: Aug. 6, 2026

(54) DIELECTRIC-GAPPED ELECTROMAGNETIC CONDUCTIVE INTERCONNECT AND ELECTRICALLY COMMUNICATING AN ALTERNATING CURRENT ELECTRICAL SIGNAL

(71) Applicant: Government of the United States of America, as represented by the Secretary of Commerce, Gaithersburg, MD (US)

(72) Inventors: Nicholas Ryan Jungwirth, Boulder, CO (US); Nathan Daniel Orloff, Louisville, CO (US); Christian John Long, Westminster, CO (US); Bryan Travis Bosworth, Golden, CO (US); Dylan Forest Williams, Boulder, CO (US)

(21) Appl. No.: 19/047,084

(22) Filed: Feb. 6, 2025

(51) Int. Cl. H01P 3/10

(52) U.S. Cl. CPC H01P 3/10

(57) ABSTRACT

A dielectric-gapped electromagnetic conductive interconnect for electrically communicating an alternating current electrical signal and that includes: a primary communications member; a distributed wireless junction; a primary wireless communicator; a primary wired extension; a primary signal line; a secondary wireless communicator; secondary wired extension; a secondary signal line; and an interstitial dielectric partition that separates and electrically insulates the primary communications member the from secondary communications member in the distributed wireless junction, such that an interstitial dielectric partition is interposed between the primary communications member and the secondary communications member in distributed wireless junction.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BRIEF DESCRIPTION

Disclosed is a dielectric-gapped electromagnetic conductive interconnect for electrically communicating an alternating current electrical signal, comprising: a primary communications member disposed on an interstitial dielectric partition and in electrical communication with a secondary communications member, the primary communications member comprising a primary wireless communicator, a primary wired extension, and a primary signal line, such that the primary communications member communicates a primary interconnect signal to the secondary communications member, and the primary communications member receives a secondary interconnect signal from the secondary communications member and communicates the secondary interconnect signal as a primary receive signal; a distributed wireless junction comprising the primary communications member, the secondary communications member, and the interstitial dielectric partition, such that the primary communications member is spaced apart from the secondary communications member and electrically insulated from the secondary communications member by the interstitial dielectric partition, the secondary communications member communicates a secondary interconnect signal to the primary communications member, and the secondary communications member receives a primary interconnect signal from the primary communications member, and comprising a junction length that tunes the frequency response of the dielectric-gapped electromagnetic conductive interconnect and a junction cross-sectional area that tunes the electromagnetic coupling of the dielectric-gapped electromagnetic conductive interconnect to a primary transceiver and a secondary transceiver; a primary wireless communicator disposed on the primary wired extension and disposed on the interstitial dielectric partition and in electromagnetic communication with a secondary wireless communicator and in electrical communication with the primary wired extension and in mechanical communication with the interstitial dielectric partition, the primary wireless communicator comprising the primary signal line; a primary wired extension disposed on the interstitial dielectric partition and in electrical communication with the primary wireless communicator and in mechanical communication with the interstitial dielectric partition, the primary wired extension comprising the primary signal line; a primary signal line disposed on the interstitial dielectric partition and in electromagnetic communication with a secondary signal line and in mechanical communication with the interstitial dielectric partition, the primary signal line extending from the primary wireless communicator to the primary wired extension, such that the primary signal line in the primary wireless communicator receives a secondary interconnect signal from the secondary signal line in the secondary wireless communicator across the interstitial dielectric partition, produces a primary receive signal from the secondary interconnect signal in the primary wired extension, receives a primary transmission signal in the primary wired extension, produces a primary interconnect signal from the primary transmission signal in the primary wireless communicator, and communicates the primary interconnect signal to the secondary signal line in the secondary wireless communicator within the distributed wireless junction; a secondary wireless communicator disposed on the secondary wired extension and disposed on the interstitial dielectric partition and in electromagnetic communication with the primary wireless communicator and in electrical communication with the secondary wired extension and in mechanical communication with the interstitial dielectric partition, the secondary wireless communicator comprising the secondary signal line; a secondary wired extension disposed on the interstitial dielectric partition and in electrical communication with the secondary wireless communicator and in mechanical communication with the interstitial dielectric partition, the secondary wired extension comprising the secondary signal line; a secondary signal line disposed on the interstitial dielectric partition and in electromagnetic communication with the primary signal line and in mechanical communication with the interstitial dielectric partition, the secondary signal line extending from the secondary wireless communicator to the secondary wired extension, such that the secondary signal line in the secondary wireless communicator receives a primary interconnect signal from the primary signal line in the primary wireless communicator across the interstitial dielectric partition, produces a secondary receive signal from the primary interconnect signal in the secondary wired extension, receives a secondary transmission signal in the primary wired extension, produces a secondary interconnect signal from the secondary transmission signal in the secondary wireless communicator, and communicates the secondary interconnect signal to the primary signal line in the primary wireless communicator within the distributed wireless junction; and an interstitial dielectric partition on which is disposed the primary communications member and on which is disposed the secondary communications member and in mechanical communication with the primary communications member and in mechanical communication with the secondary communications member and that separates and electrically insulates the primary communications member from the secondary communications member in the distributed wireless junction, such that the interstitial dielectric partition is interposed between the primary communications member and the secondary communications member in the distributed wireless junction.

Disclosed is a process for electrically communicating an alternating current electrical signal with a dielectric-gapped electromagnetic conductive interconnect, the process comprising: disposing a primary communications member on an interstitial dielectric partition; disposing a secondary communications member on the interstitial dielectric partition; electrically connecting the primary communications member to the secondary communications member; communicating an alternating current electrical signal between the primary communications member and the secondary communications member; and receiving the alternating current electrical signal at the secondary communications member.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows, according to some embodiments, a dielectric-gapped electromagnetic conductive interconnect 200.

FIG. 2 shows, according to some embodiments, a perspective view of a dielectric-gapped electromagnetic conductive interconnect 200.

FIG. 3 shows, according to some embodiments, a plan view of a perspective view of a dielectric-gapped electromagnetic conductive interconnect 200.

FIG. 4 shows, according to some embodiments, a cross-section along line A-A of the dielectric-gapped electromagnetic conductive interconnect 200 shown in FIG. 3.

FIG. 5 shows, according to some embodiments, a cross-section along line B-B of the dielectric-gapped electromagnetic conductive interconnect 200 shown in FIG. 3.

FIG. 6 shows, according to some embodiments, a cross-section along line C-C of the dielectric-gapped electromagnetic conductive interconnect 200 shown in FIG. 3.

FIG. 7 shows, according to some embodiments, a cross-section along line D-D of the dielectric-gapped electromagnetic conductive interconnect 200 shown in FIG. 3.

FIG. 8 shows, according to some embodiments, a dielectric-gapped electromagnetic conductive interconnect 200.

FIG. 9 shows, according to some embodiments, a dielectric-gapped electromagnetic conductive interconnect 200 configured as an edge-coupled coaxial cable working example of distributed contactless interconnect.

FIG. 10 shows, according to some embodiments, a first transmission member 213 or a second transmission member 216 configured as a coaxial cable.

FIG. 11 shows, according to some embodiments, a first transmission member 213 or a second transmission member 216 configured as a microstrip line.

FIG. 12 shows, according to some embodiments, a first transmission member 213 or a second transmission member 216 configured as a coplanar waveguide.

FIG. 13 shows, according to some embodiments, a process for making dielectric-gapped electromagnetic conductive interconnect 200.

FIG. 14 shows, according to some embodiments, a computing device for implementing processes, calculations, optimizations, and controls, described herein.

FIG. 15 shows (Top) 3D design of interconnect test structure. The translucent planes indicate cross-sections of interest. The transverse cross-section shows our broadside-coupled CPW distributed interconnect. The longitudinal cross section (Bottom) divides the structure into distinct regions. The contactless interconnect is contained in the regions of overlap, labeled IC.

FIG. 16 shows a fabrication process flow for the interconnect test structures investigated in this work. Side view perspectives are cross-sections of the dashed vertical line in the corresponding plan view. Micrographs are optical microscope images of the interconnect test structure at each fabrication step.

FIG. 17 shows simulated and experimentally measured transmission (S₁₂, (a)) and reflection (S₁₁, (b)) coefficients for interconnect test structures with coupling lengths l_{c} equal to (top row) 500 μm, (middle row) 250 μm, and (bottom row) 125 μm. The maximum simulated transmission in each passband is indicated by the blue circular marker in (a). The dashes lines in (a) represent the net insertion loss of the transmission line regions and therefore set an upper bound on the transmission of the back-to-back configuration.

FIG. 18 shows (a) 3D design of broadside-coupled CPWs and associated two-port network model of the interconnect. (b) Cross-sectional geometry of the translucent plane in (a). Distributed circuit model in the conductor representation (c) and modal representation (d) for N=2 coupled lines.

FIG. 19 shows a conductor-representation distributed circuit parameters of resistance (a), inductance (b), conductance (c) and capacitance (d) per unit length.

FIG. 20 shows interconnect transmission (S₁₂) predicted by full-wave simulations (red curves) and our analytical, parameter-free, two-mode model (dashed curves) for l_{c}=500 μm (a), 250 μm (b), 125 μm (c), and 60 μm (d). The transmission band maxima (fₙ) and bandwidth (Δfₙ) increase as the coupling length decreases.

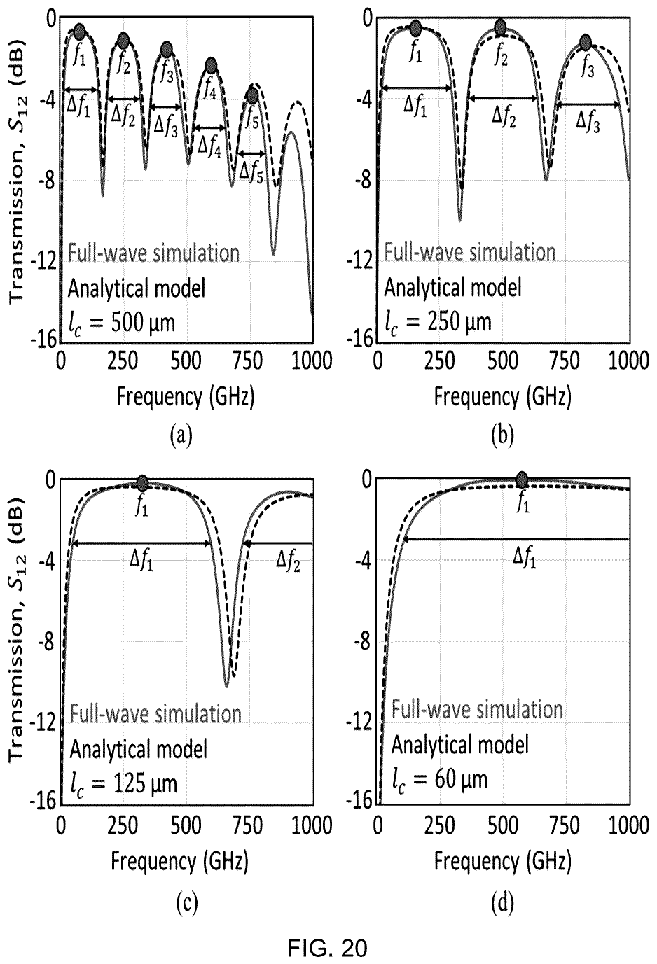

### DETAILED DESCRIPTION

A detailed description of one or more embodiments is presented herein by way of exemplification and not limitation.

Conventional interconnects, such as those made of copper or aluminum, suffer from a number of limitations. For example, they are susceptible to corrosion and oxidation, which can lead to signal degradation and even failure. Additionally, conventional interconnects can be bulky and expensive, making them unsuitable for use in certain applications.

It should be appreciated that next generation integrated circuits for 5G are speculated to integrate multiple semiconductor technologies to optimize speed, efficiency, and cost. These devices must modularly integrate different semiconductor technologies. An example hybrid electronic architecture is coupling a photomixer to an amplifier, wherein the photomixer has an output transmission line, and the amplifier has an input transmission line, e.g., a coplanar waveguide. To achieve such a result, it was discovered that a dielectric-gapped electromagnetic conductive interconnect 200 can include the input transmission of the amplifier suspending over and overlapping the output transmission line of the photomixer. The region of overlap is a distributed wireless junction 203. Distributed wireless junction 203 wirelessly communicates electrical signals from primary communications member 201 to secondary communications member 202. Advantageously, the cross-sectional geometry of dielectric-gapped electromagnetic conductive interconnect 200 can be configured to optimize the coupling between primary communications member 201 and secondary communications member 202 in distributed wireless junction 203. Beneficially, the junction length 232 of distributed wireless junction 203 can be changed to tune the frequency response of dielectric-gapped electromagnetic conductive interconnect 200.

The dielectric-gapped electromagnetic conductive interconnect 200 is also more compact and less expensive than conventional interconnects. This is because the dielectric material 210 can be made of a variety of materials, including ceramics, polymers, and glasses. These materials are often less expensive than copper or aluminum, and they can be manufactured using a variety of techniques, including injection molding, extrusion, and lamination. The dielectric-gapped electromagnetic conductive interconnect 200 is suitable for use in a variety of applications, including those where corrosion and oxidation are a concern. Further, dielectric-gapped electromagnetic conductive interconnect 200 transmits alternating current (ac) electrical signals from one transmission line to another transmission line without the need for either transmission line to be in direct electrical contact. The two transmission lines can be in two signal transmission layers of a multilayer monolithic process or can be signal transmission layers in two distinct fabrication processes, e.g., two chips fabricated separately.

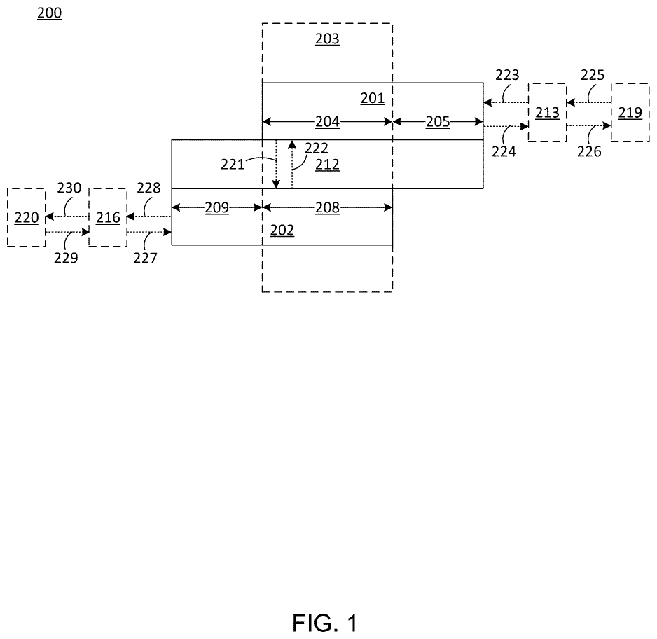

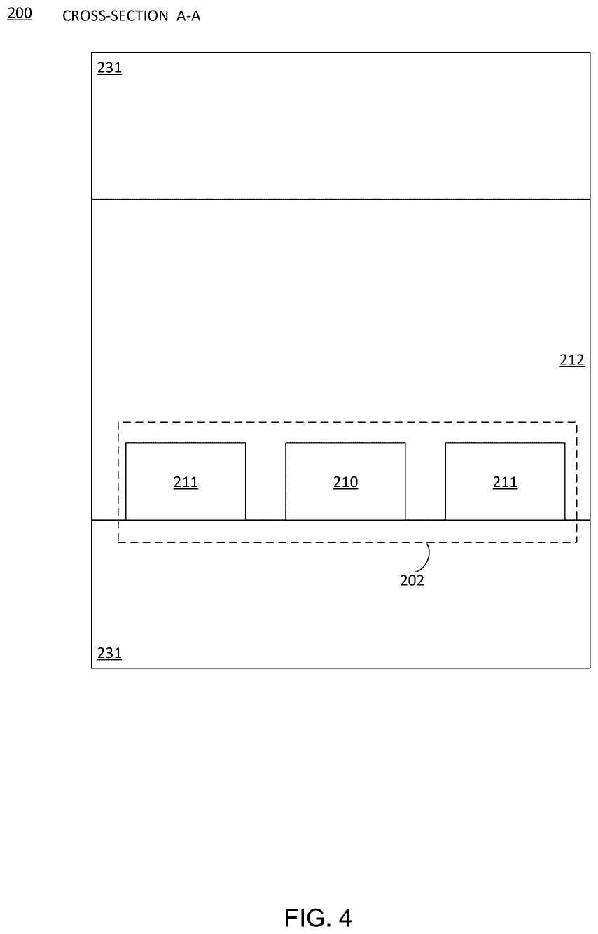

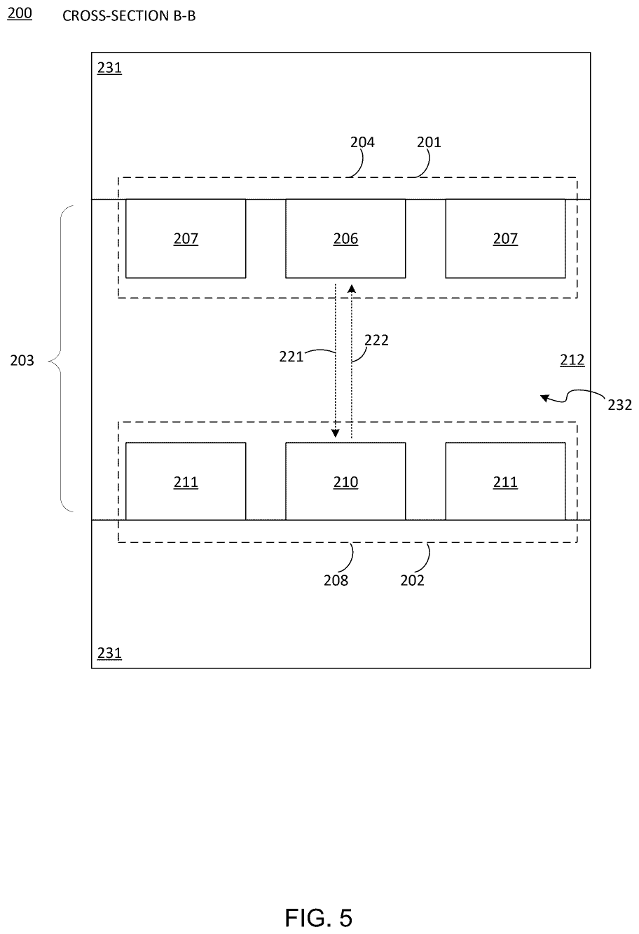

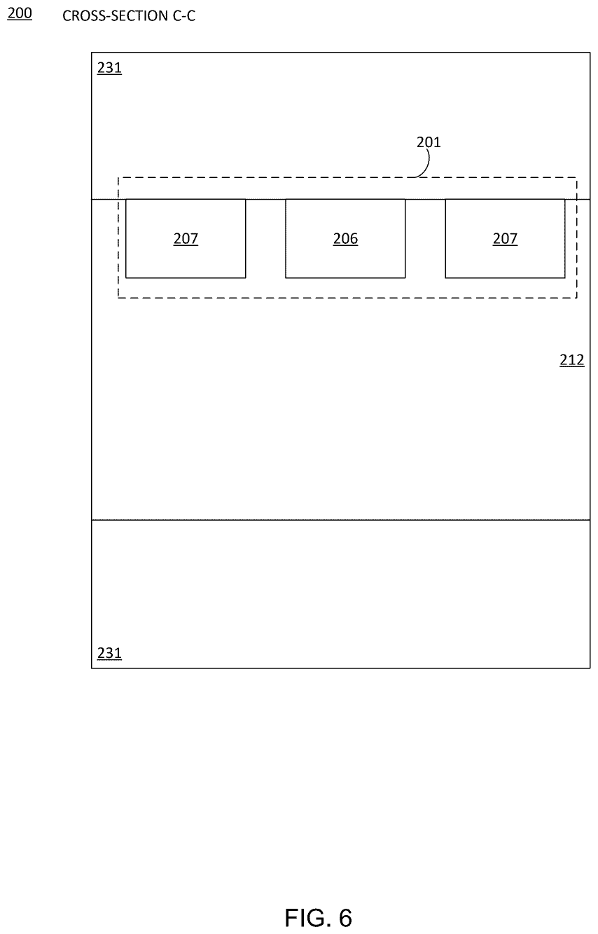

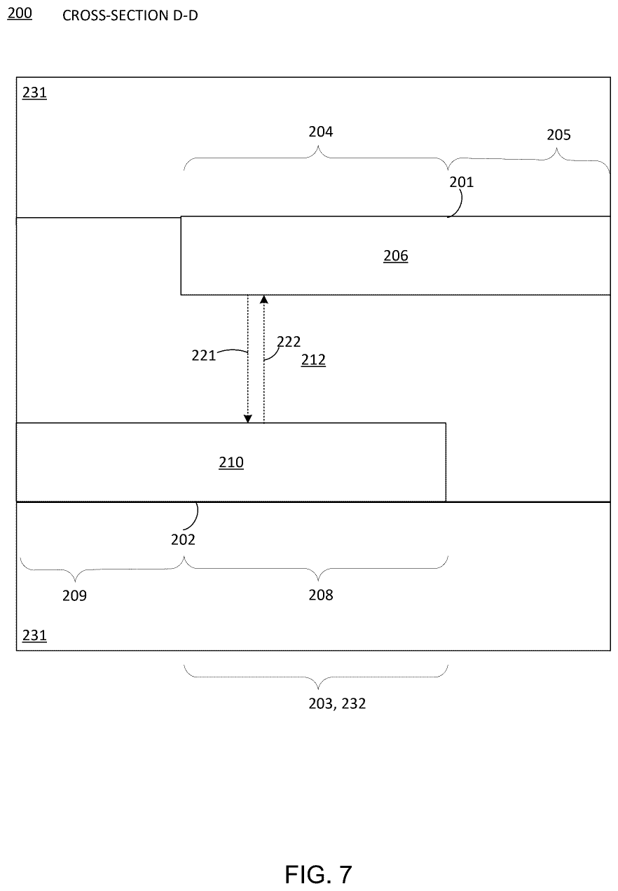

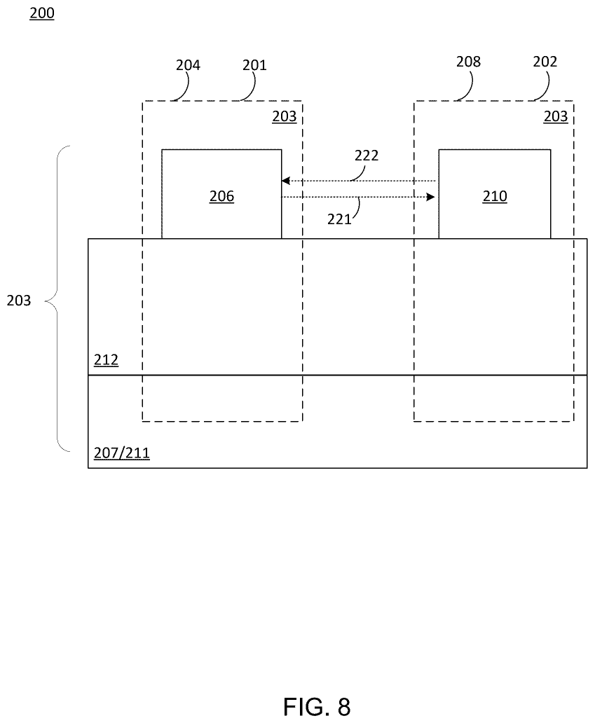

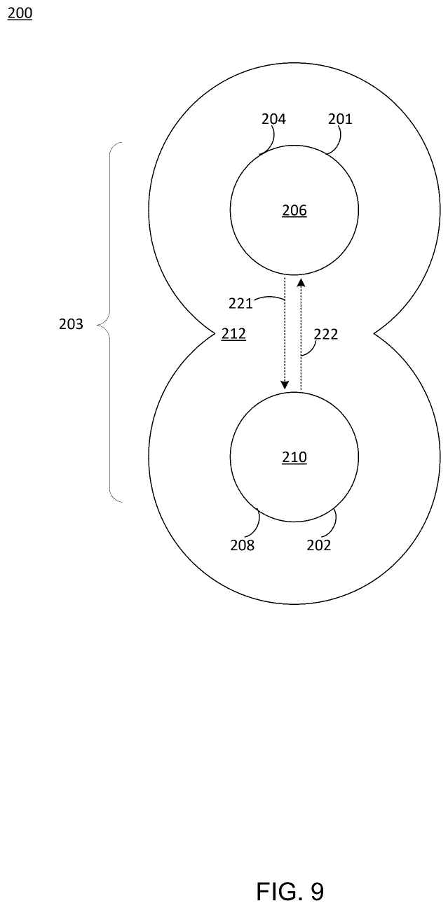

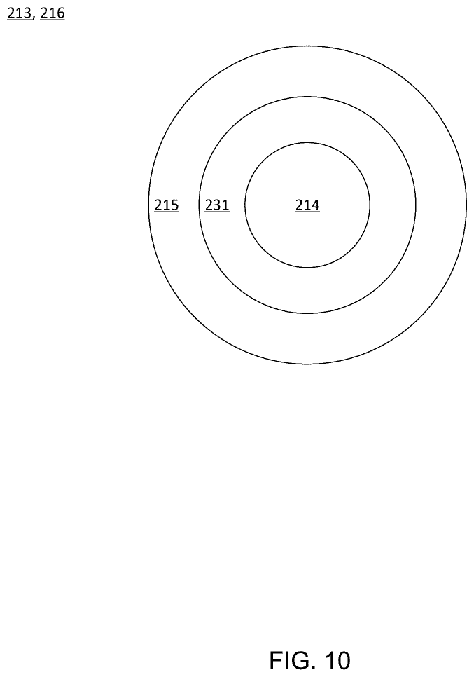

Dielectric-gapped electromagnetic conductive interconnect 200 electrically communicates an alternating current electrical signal. In an embodiment, with reference to FIG. 1 to FIG. 10, dielectric-gapped electromagnetic conductive interconnect 200 for electrically communicating an alternating current electrical signal includes: a primary communications member (201) disposed on an interstitial dielectric partition (212) and in electrical communication with a secondary communications member (202) and that comprises a primary wireless communicator (204), a primary wired extension (205), and a primary signal line (206), such that the primary communications member (201) communicates a primary interconnect signal (221) to the secondary communications member (202) and receives a secondary interconnect signal (222) from the secondary communications member (202) and communicates the secondary interconnect signal (222) as a primary receive signal (224); a distributed wireless junction (203) that comprises the primary communications member (201), the secondary communications member (202), and the interstitial dielectric partition (212), such that the primary communications member (201) is spaced apart from the secondary communications member (202) and electrically insulated from the secondary communications member (202) by the interstitial dielectric partition (212), the secondary communications member (202) communicates the secondary interconnect signal (222) to the primary communications member (201), and the secondary communications member (202) receives the primary interconnect signal (221) from the primary communications member (201), and comprises a junction length (232) that tunes the frequency response of the dielectric-gapped electromagnetic conductive interconnect (200) and a junction cross-sectional area (233) that tunes the electromagnetic coupling of the dielectric-gapped electromagnetic conductive interconnect (200) to a primary transceiver (219) and a secondary transceiver (220); a primary wireless communicator (204) disposed on the primary wired extension (205) and disposed on the interstitial dielectric partition (212) and in electromagnetic communication with a secondary wireless communicator (208) and in electrical communication with the primary wired extension (205) and in mechanical communication with the interstitial dielectric partition (212) and that comprises the primary signal line (206); a primary wired extension (205) disposed on the interstitial dielectric partition (212) and in electrical communication with the primary wireless communicator (204) and in mechanical communication with the interstitial dielectric partition (212) and that comprises the primary signal line (206); a primary signal line (206) disposed on the interstitial dielectric partition (212) and in electromagnetic communication with a secondary signal line (210) and in mechanical communication with the interstitial dielectric partition (212) and that extends from the primary wireless communicator (204) to the primary wired extension (205), such that the primary signal line (206) in the primary wireless communicator (204) receives the secondary interconnect signal (222) from the secondary signal line (210) in the secondary wireless communicator (208) across the interstitial dielectric partition (212), produces a primary receive signal (224) from the secondary interconnect signal (222) in the primary wired extension (205), receives a primary transmission signal (223) in the primary wired extension (205), produces a primary interconnect signal (221) from the primary transmission signal (223) in the primary wireless communicator (204), and communicates the primary interconnect signal (221) to the secondary signal line (210) in the secondary wireless communicator (208) within the distributed wireless junction (203); a secondary wireless communicator (208) disposed on the secondary wired extension (209) and disposed on the interstitial dielectric partition (212) and in electromagnetic communication with the primary wireless communicator (204) and in electrical communication with the secondary wired extension (209) and in mechanical communication with the interstitial dielectric partition (212) and that comprises the secondary signal line (210); a secondary wired extension (209) disposed on the interstitial dielectric partition (212) and in electrical communication with the secondary wireless communicator (208) and in mechanical communication with the interstitial dielectric partition (212) and that comprises the secondary signal line (210); secondary signal line 210 disposed on interstitial dielectric partition 212 and in electromagnetic communication with primary signal line 206 and in mechanical communication with interstitial dielectric partition 212 and that extends from secondary wireless communicator 208 to secondary wired extension 209, such that secondary signal line 210 in secondary wireless communicator 208 receives primary interconnect signal 221 from primary signal line 206 in primary wireless communicator 204 across interstitial dielectric partition 212, produces secondary receive signal 228 from primary interconnect signal 221 in secondary wired extension 209, receives secondary transmission signal 227 in primary wired extension 205, produces secondary interconnect signal 222 from secondary transmission signal 227 in secondary wireless communicator 208, and communicates secondary interconnect signal 222 to primary signal line 206 in primary wireless communicator 204 within distributed wireless junction 203; and interstitial dielectric partition 212 on which is disposed primary communications member 201 and secondary communications member 202 and in mechanical communication with primary communications member 201 and in mechanical communication with secondary communications member 202 and that separates and electrically insulates primary communications member 201 from secondary communications member 202 in distributed wireless junction 203, such that interstitial dielectric partition 212 is interposed between primary communications member 201 and secondary communications member 202 in distributed wireless junction 203.

In an embodiment, dielectric-gapped electromagnetic conductive interconnect 200 includes: a primary ground line 207 disposed on interstitial dielectric partition 212 and in electromagnetic communication with primary signal line 206 and in mechanical communication with interstitial dielectric partition 212, wherein primary wireless communicator 204 and primary wired extension 205 further comprise primary ground line 207, such that primary ground line 207 extends from primary wireless communicator 204 to primary wired extension 205 and provides an electrical ground reference for primary signal line 206.

In an embodiment, dielectric-gapped electromagnetic conductive interconnect 200 includes: a secondary ground line 211 disposed on interstitial dielectric partition 212 and in electromagnetic communication with secondary signal line 210 and in mechanical communication with interstitial dielectric partition 212 and that wherein secondary wireless communicator 208 and secondary wired extension 209 further comprise secondary ground line 211, such that secondary ground line 211 extends from secondary wireless communicator 208 to secondary wired extension 209 and provides an electrical ground reference for secondary signal line 210.

In an embodiment, dielectric-gapped electromagnetic conductive interconnect 200 includes: a first transmission member 213 in electrical communication with primary communications member 201 and that receives first transmit transceiver signal 225, produces primary transmission signal 223 from first transmit transceiver signal 225, communicates primary transmission signal 223 to primary communications member 201, receives primary receive signal 224 from primary communications member 201, and produces first receive transceiver signal 226 from primary receive signal 224.

In an embodiment, dielectric-gapped electromagnetic conductive interconnect 200 includes: a first transmission signal line 214 disposed on a first transmission member 213 and in electrical communication with primary signal line 206, wherein the first transmission member 213 comprises the first transmission signal line 214 and a first transmission ground line 215, such that the first transmission signal line 214 receives a first transmit transceiver signal 225, produces a primary transmission signal 223 from the first transmit transceiver signal 225, communicates the primary transmission signal 223 to the primary signal line 206 of the primary communications member 201 in the primary wired extension 205, receives a primary receive signal 224 from the primary signal line 206 in the primary wired extension 205, and produces a first receive transceiver signal 226 from the primary receive signal 224; and a first transmission ground line 215 disposed on the first transmission member 213 and in electromagnetic communication with the first transmission signal line 214 and that provides an electrical ground reference for the first transmission signal line 214.

In an embodiment, dielectric-gapped electromagnetic conductive interconnect 200 includes: a second transmission member 216 in electrical communication with secondary communications member 202 and that receives second transmit transceiver signal 229, produces secondary transmission signal 227 from second transmit transceiver signal 229, communicates secondary transmission signal 227 to secondary communications member 202, receives secondary receive signal 228 from secondary communications member 202, and produces first receive transceiver signal 230 from secondary receive signal 228.

In an embodiment, dielectric-gapped electromagnetic conductive interconnect 200 includes: a second transmission signal line 217 disposed on a second transmission member 216 and in electrical communication with secondary signal line 210, wherein the second transmission member 216 comprises the second transmission signal line 217 and a second transmission ground line 218, such that the second transmission signal line 217 receives a second transmit transceiver signal 229, produces a secondary transmission signal 227 from the second transmit transceiver signal 229, communicates the secondary transmission signal 227 to the secondary signal line 210 of the secondary communications member 202 in the secondary wired extension 209, receives a secondary receive signal 228 from the secondary signal line 210 in the secondary wired extension 209, and produces a first receive transceiver signal 230 from the secondary receive signal 228; and a second transmission ground line 218 disposed on the second transmission member 216 and in electromagnetic communication with the second transmission signal line 217 and that provides an electrical ground reference for the second transmission signal line 217.

In an embodiment, dielectric-gapped electromagnetic conductive interconnect 200 includes a primary transceiver 219 in electromagnetic communication with a first transmission member 213 and that produces a first transmit transceiver signal 225 and communicates the first transmit transceiver signal 225 to the first transmission member 213 and receives a first receive transceiver signal 226 from the first transmission member 213.

In an embodiment, dielectric-gapped electromagnetic conductive interconnect 200 includes a secondary transceiver 220 in electromagnetic communication with second transmission member 216 and that produces second transmit transceiver signal 229 and communicates second transmit transceiver signal 229 to second transmission member 216 and receives first receive transceiver signal 230 from second transmission member 216.

In an embodiment, dielectric-gapped electromagnetic conductive interconnect 200 includes a dielectric layer 231 disposed on primary communications member 201 and disposed on secondary communications member 202 and that electrically insulates primary communications member 201 and secondary communications member 202.

Dielectric-gapped electromagnetic conductive interconnect 200 can be made of various elements and components that can be assembled together or fabricated. Elements of dielectric-gapped electromagnetic conductive interconnect 200 can be various sizes and shapes. Elements of dielectric-gapped electromagnetic conductive interconnect 200 can be made of a material that is physically or chemically resilient in an environment in which dielectric-gapped electromagnetic conductive interconnect 200 is disposed. Exemplary materials include a metal, ceramic, thermoplastic, glass, semiconductor, and the like. The elements of dielectric-gapped electromagnetic conductive interconnect 200 can be made of the same or different material and can be monolithic in a single physical body or can be separate members that are physically joined.

The dielectric-gapped electromagnetic conductive interconnect 200 is a device for electrically communicating an alternating current electrical signal. It comprises a primary communications member 201, a secondary communications member 202, and an interstitial dielectric partition 212. The primary communications member 201 is disposed on the interstitial dielectric partition 212 and in electrical communication with the secondary communications member 202. The primary communications member 201 comprises a primary wireless communicator 204, a primary wired extension 205, and a primary signal line 206. The primary wireless communicator 204 is disposed on the primary wired extension 205 and in electromagnetic communication with the secondary wireless communicator 208. The primary wired extension 205 is in electrical communication with the primary wireless communicator 204 and in mechanical communication with the interstitial dielectric partition 212. The primary signal line 206 is disposed on the interstitial dielectric partition 212 and in electromagnetic communication with the secondary signal line 210. The primary signal line 206 extends from the primary wireless communicator 204 to the primary wired extension 205.

The secondary communications member 202 is disposed on the interstitial dielectric partition 212 and in electrical communication with the primary communications member 201. The secondary communications member 202 comprises a secondary wireless communicator 208, a secondary wired extension 209, and a secondary signal line 210. The secondary wireless communicator 208 is disposed on the secondary wired extension 209 and in electromagnetic communication with the primary wireless communicator 204. The secondary wired extension 209 is in electrical communication with the secondary wireless communicator 208 and in mechanical communication with the interstitial dielectric partition 212. The secondary signal line 210 is disposed on the interstitial dielectric partition 212 and in electromagnetic communication with the primary signal line 206. The secondary signal line 210 extends from the secondary wireless communicator 208 to the secondary wired extension 209.

The interstitial dielectric partition 212 is disposed on the primary communications member 201 and on the secondary communications member 202 and in mechanical communication with the primary communications member 201 and in mechanical communication with the secondary communications member 202. The interstitial dielectric partition 212 separates and electrically insulates the primary communications member 201 from the secondary communications member 202.

The dielectric-gapped electromagnetic conductive interconnect 200 can further comprise a dielectric layer 231 disposed on the primary communications member 201 and on the secondary communications member 202. The dielectric layer 231 electrically insulates the primary communications member 201 from the secondary communications member 202.

The dielectric-gapped electromagnetic conductive interconnect 200 can be used in a variety of applications, such as in telecommunications, data communications, and power transmission.

The primary communications member 201 includes an electrically conductive member that is disposed on the interstitial dielectric partition 212 and in electromagnetic communication with the secondary communications member 202. The primary communications member 201 comprises a primary wireless communicator 204, a primary wired extension 205, a primary signal line 206, and optionally primary ground line 207. The primary wireless communicator 204 is disposed on the primary wired extension 205 and in electromagnetic communication with the secondary wireless communicator 208. The primary wireless communicator 204 includes a primary signal line 206. The primary wired extension 205 is disposed on the interstitial dielectric partition 212 and in electromagnetic communication with the primary wireless communicator 204. The primary wired extension 205 includes the primary signal line 206. The primary signal line 206 is disposed on the interstitial dielectric partition 212 and in electromagnetic communication with the secondary signal line 210. The primary signal line 206 extends from the primary wireless communicator 204 to the primary wired extension 205. The primary communications member 201 includes a conductive material (e.g., for primary signal line 206), such as copper or aluminum. The primary communications member 201 has a length, a width, and a thickness suitable for supporting communication with secondary communications member 202. The length of the primary communications member 201 can be greater than the width of the primary communications member 201. The thickness of the primary communications member 201 is less than the width of the primary communications member 201. The primary communications member 201 has a surface area that can be greater than the cross-sectional area of the primary signal line 206. The primary communications member 201 has portions (e.g., primary signal line 206) that are electrically conductive. The primary communications member 201 can carry an electrical current along primary signal line 206. The primary communications member 201 can transmit an electrical signal, e.g., from primary signal line 206. The primary communications member 201 is capable of receiving an electrical signal. The primary communications member 201 is mechanically strong and capable of withstanding mechanical forces, environmental conditions, and wear and tear.

The secondary communications member 202 includes a conductive member that is disposed on the interstitial dielectric partition 212 and in electrical communication with the primary communications member 201. The secondary communications member 202 can include a plurality of conductive elements that are disposed in a spaced-apart relationship to one another. The conductive elements can be electrically conductive as conductive traces that are disposed on the interstitial dielectric partition 212. The secondary communications member 202 is configured to receive a primary interconnect signal 221 from the primary communications member 201 and to communicate the secondary interconnect signal 222 to the primary communications member 201. Portions of secondary communications member 202 can be made of a variety of conductive materials, such as copper, silver, or gold. The conductive elements can be made of a variety of shapes, such as wires, strips, or ribbons. The conductive traces cab be made of a variety of shapes, such as lines, curves, or spirals. The secondary communications member 202 can be configured to receive a variety of primary interconnect signals 221, such as digital signals, analog signals, or radio frequency signals. The secondary communications member 202 can be configured to communicate a variety of secondary interconnect signals 222, such as digital signals, analog signals, or radio frequency signals. The secondary communications member 202 can be configured to operate in a variety of environments, such as high-temperature environments, low-temperature environments, or harsh environments. The secondary communications member 202 can be configured to be resistant to a variety of environmental factors, such as heat, cold, moisture, or chemicals.

The distributed wireless junction 203 is a component of the dielectric-gapped electromagnetic conductive interconnect 200 and includes primary communications member 201, secondary communications member 202, and interstitial dielectric partition 212, such that primary communications member 201 is spaced apart from secondary communications member 202 and electrically insulated from secondary communications member 202 by interstitial dielectric partition 212, secondary communications member 202 communicates secondary interconnect signal 222 to primary communications member 201, and secondary communications member 202 receives primary interconnect signal 221 from primary communications member 201, and includes junction length 232 that tunes the frequency response of dielectric-gapped electromagnetic conductive interconnect 200 and junction cross-sectional area 233 that tunes the electromagnetic coupling of dielectric-gapped electromagnetic conductive interconnect 200, e.g., to primary transceiver 219 and secondary transceiver 220. The distributed wireless junction 203 has a number of advantages over conventional interconnects. It is able to provide a high-speed, low-loss connection between primary communications member 201 and secondary communications member 202 because the junction length 232 can be relatively short, and the junction cross-sectional area 233 can be relatively large. Distributed wireless junction 203 withstands high levels of electromagnetic interference because the interstitial dielectric partition 212 provides a high degree of electrical insulation between primary communications member 201 and secondary communications member 202. The distributed wireless junction 203 is relatively easy to manufacture and can be a two-dimensional structure.

The primary wireless communicator 204 transmits and receives wireless signals (e.g., primary interconnect signal 221, secondary interconnect signal 222). It is disposed on the primary wired extension 205 and is in electromagnetic communication with the secondary wireless communicator 208. The primary wireless communicator 204 includes a primary signal line 206 and optionally primary ground line 207. The primary signal line 206 is a conductor that carries the electrical signal between the primary wireless communicator 204 and the primary wired extension 205. The primary wireless communicator 204 can be small and lightweight, which makes it easy to incorporate into the interconnect. Primary wireless communicator 204 can have a high frequency response, such that it transmits and receives high-frequency signals. Primary wireless communicator 204 can have a low noise figure such that it can receive weak signals without adding much noise. Primary wireless communicator 204 can have a wide dynamic range such that it can handle a large range of signal strengths. Primary wireless communicator 204 can have a good power efficiency, such that it can transmit a strong signal with a low power consumption.

The primary wired extension 205 includes a conductive element (e.g., primary signal line 206) that extends from the primary wireless communicator 204. Primary wired extension 205 is disposed on the interstitial dielectric partition 212 and is in part in electrical communication with the primary wireless communicator 204. The primary wired extension 205 includes some material that is conductive and has a low dielectric constant. This allows portions of primary wired extension 205 (e.g., primary signal line 206) to efficiently transmit electrical signals between the primary wireless communicator 204 along primary signal line 206. The primary wired extension 205 is also mechanically robust and can withstand the rigors of everyday use. The primary wired extension 205 can include a material that is electrically conductive, which allows it to efficiently transmit electrical signals. The primary wired extension 205 includes portions that have a low dielectric constant, which minimizes the loss of electrical signal as it travels through the interconnect.

The primary signal line 206 is a conductive element that extends from the primary wireless communicator 204 to the primary wired extension 205. It is disposed on the interstitial dielectric partition 212 and is in electromagnetic communication with the secondary signal line 210. The primary signal line 206 is made of a material that has a high electrical conductivity, such as copper or silver. It can have a selected diameter, typically on the order of a few microns, which allows it to carry high frequencies without significant attenuation. The primary signal line 206 can be electrically insulated from secondary signal line 210 by dielectric layer 231. This layer prevents current from flowing between primary signal line 206 and secondary signal line 210 and allows the primary signal line 206 to maintain its high electrical conductivity.

The primary ground line 207 is a conductive element that is disposed on primary communications member 201 and primary wired extension 205. The primary ground line 207 provides a ground reference for voltage applied to primary signal line 206. The primary ground line 207 can be made of a conductive material such as copper or aluminum. The primary ground line 207 can be disposed on the surface of primary communications member 201, or it can be disposed within the structure of primary communications member 201. The primary ground line 207 can improve the performance of dielectric-gapped electromagnetic conductive interconnect 200 by providing a low-impedance for current and reducing signal attenuation to improve signal-to-noise ratio. The primary ground line 207 can protect primary communications member 201 from electromagnetic interference. Electromagnetic interference can cause noise to be introduced into primary signal line 206. The primary ground line 207 helps to shield primary communications member 201 from electromagnetic interference by providing a conductive path for current to flow away from primary communications member 201. This helps to reduce the amount of noise that is introduced into primary signal line 206.

The secondary wireless communicator 208 is a wireless transceiver that is disposed on the secondary wired extension 209 and is in electromagnetic communication with the primary wireless communicator 204. The secondary wireless communicator 208 includes a secondary signal line 210 and optionally secondary ground line 211. The secondary signal line 210 is in communication with the secondary transceiver 220 and extends from secondary wired extension 209 into distributed wireless junction 203. The secondary transceiver 220 is an electromagnetic transceiver that receives and transmits electromagnetic signals. The secondary wireless communicator 208 is configured to communicate with the primary wireless communicator 204 via electromagnetic signals (e.g., primary interconnect signal 221, secondary interconnect signal 222). The secondary wireless communicator 208 can be small and lightweight to integrate into the dielectric-gapped electromagnetic conductive interconnect 200. The secondary wireless communicator 208 can be rugged and reliable for use in harsh environments. The secondary wireless communicator 208 can be efficient, consuming little power.

The secondary wired extension 209 includes a conductive element that extends from the secondary wireless communicator 208. Secondary wired extension 209 can include a material that is both electrically conductive and mechanically strong, such as copper or aluminum. The secondary wired extension 209 can be insulated with a dielectric material, such as Teflon or PTFE or polymer resin, to prevent electrical shorts. The secondary wired extension 209 can support a good conductor of electricity to carry the signal from the secondary wireless communicator 208 to second transmission member 216. Secondary wired extension 209 can be mechanically strong to withstand the forces that are exerted on it during assembly and use. Secondary wired extension 209 can be insulated with a dielectric material to prevent electrical shorts.

The secondary signal line 210 is a conductive element that extends from the secondary wireless communicator 208 to the secondary wired extension 209. It is disposed on the interstitial dielectric partition 212 and is in electromagnetic communication with the primary signal line 206. The secondary signal line 210 is made of a material that has a high electrical conductivity, such as copper or silver. It has a selected cross-sectional area to minimize its resistance to current flow. The secondary signal line 210 can be electrically insulated from secondary ground line 211 by a dielectric layer 231. This layer prevents the secondary signal line 210 from shorting to secondary ground line 211.

The secondary ground line 211 is a conductive element that is disposed on the interstitial dielectric partition 212 and secondary communications member 202. The secondary ground line 211 can provide a return path for current flowing through the secondary communications member 202 and can shield the secondary communications member 202 from electromagnetic interference. The secondary ground line 211 can be made of a variety of conductive materials, such as copper, aluminum, or silver. The thickness of the secondary ground line 211 can vary depending on the specific application, but can be on the order of a few micrometers. The secondary ground line 211 can be disposed on the interstitial dielectric partition 212 in a line, serpentine, or zigzag pattern to increase the surface area of the secondary ground line 211, which increases its ability to shield the secondary communications member 202 from electromagnetic interference.

The interstitial dielectric partition 212 is a non-conductive layer of material that is interposed between the primary and secondary communications members 201 and 202 in distributed wireless junction 203. It electrically insulates the two members and prevents them from shorting to one another. The interstitial dielectric partition 212 can be made of a variety of materials, including ceramics, plastics, and glass. It can be chosen for its electrical properties, its mechanical properties, and its compatibility with the other materials in the dielectric-gapped electromagnetic conductive interconnect 200. The interstitial dielectric partition 212 has a high dielectric constant to insulate the primary and secondary communications members 201 and 202. The interstitial dielectric partition 212 has a high breakdown voltage to withstand high voltages that can be present in the dielectric-gapped electromagnetic conductive interconnect 200. The breakdown voltage is the voltage at which a material will break down and allow current to flow, wherein a high breakdown voltage material withstands high voltages without breaking down. The interstitial dielectric partition 212 can be mechanically strong to withstand stresses that can be present in the dielectric-gapped electromagnetic conductive interconnect 200. The interstitial dielectric partition 212 can be compatible with the other materials in the dielectric-gapped electromagnetic conductive interconnect 200 so it does not react with the other materials or cause them to degrade.

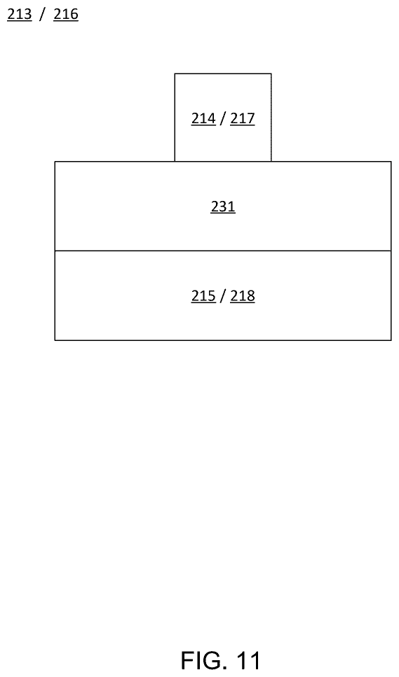

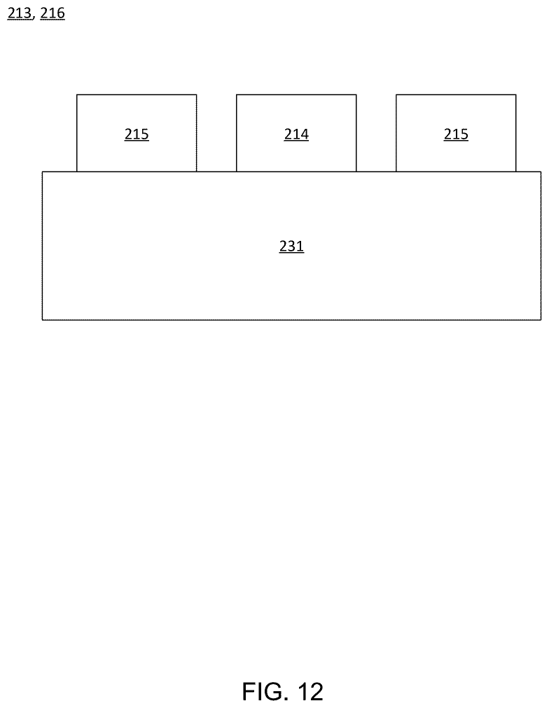

The first transmission member 213 is in electrical communication with primary communications member 201. The first transmission member 213 includes a material that has a high electrical conductivity and a low dielectric constant to efficiently transmit electrical signals between primary communications member 201 and primary transceiver 219. In an embodiment, with reference to FIG. 11 to FIG. 13, first transmission member 213 includes first transmission signal line 214 disposed on dielectric layer 231 and first transmission ground line 215 disposed on dielectric layer 231, wherein dielectric layer 231 is interposed between first transmission signal line 214 and first transmission ground line 215 so that first transmission signal line 214 and first transmission ground line 215 are electrically isolated from one another. The first transmission member 213 has a low resistance in its electrically conductive portions, which minimizes power losses. The first transmission member 213 can be made of a variety of materials, including copper, silver, and gold along with suitable dielectric to insulate electrically conductive members from one another. The material used for the first transmission member 213 can depend on the specific application. For example, if the dielectric-gapped electromagnetic conductive interconnect 200 is used in a high-frequency application, then a material with a high electrical conductivity and a low dielectric constant, such as copper, can be used. The first transmission member 213 can be in a variety of shapes and sizes. The shape and size of the first transmission member 213 can depend on the specific application. For example, if the dielectric-gapped electromagnetic conductive interconnect 200 is used in a small, portable device, then the first transmission member 213 can be made small and thin. Exemplary second transmission members 216 include photodetectors, amplifiers, coaxial cables, and the like.

The first transmission signal line 214 of first transmission member 213 is disposed on dielectric layer 231 and is in electromagnetic communication with primary signal line 206. The first transmission signal line 214 is made of a conductive material, such as copper or aluminum. The first transmission signal line 214 has a characteristic impedance of Z₀. The first transmission signal line 214 can be terminated with a resistor. The first transmission signal line 214 transmits an alternating current electrical signal primary receive signal 224 from primary communications member 201 to primary transceiver 219. First transmission signal line 214 has a number of properties suited to dielectric-gapped electromagnetic conductive interconnect 200. The attenuation of the first transmission signal line 214 is a measure of how much the signal is reduced in amplitude as it travels along the line. The attenuation is given by A=20 log₁₀(I₀/I), wherein I₀ is the input current and I is the output current. The reflection of the first transmission signal line 214 is a measure of how much of the signal is reflected back at the input when it reaches the end of the line. The reflection coefficient is given by R=(Z₀−Z)/(Z₀+Z), wherein where Z₀ is the characteristic impedance of the line and Z is the load impedance. The delay of the first transmission signal line 214 is given by T=L/v, wherein L is the length of the line and v is the velocity of propagation. The phase shift of the first transmission signal line 214 is a measure of how the phase of the signal changes as it travels along the line and is given by φ=2πL/v, wherein L is the length of the line and v is the velocity of propagation. The voltage standing wave ratio (VSWR) of the first transmission signal line 214 is a measure of how much the voltage varies along the line. The VSWR is given by VSWR=Vₘₐₓ/Vₘᵢₙ, wherein Vₘₐₓ is the maximum voltage and Vₘᵢₙ is the minimum voltage. The return loss of the first transmission signal line 214 is a measure of how much of the signal is reflected back at the input, wherein the return loss is given by RL=10 log₁₀(1−|R|2) where R is the reflection coefficient.

The first transmission ground line 215 is a conductive line of first transmission member 213 that is disposed on dielectric layer 231 and spaced apart from first transmission signal line 214 and that electrically communicates signals between primary communications member 201 and primary transceiver 219. The first transmission ground line 215 can be made of a material such as copper or aluminum. The first transmission ground line 215 can be disposed on dielectric layer 231 in a straight line or a serpentine or zigzag pattern with a selected length. The first transmission ground line 215 can provide a low-impedance path for current to flow between primary communications member 201 and primary transceiver 219, and it also can reduce electromagnetic interference between primary communications member 201 and primary transceiver 219. The first transmission ground line 215 has a length that is appropriate for the frequency range of operation of the dielectric-gapped electromagnetic conductive interconnect 200. This length helps to ensure that the first transmission ground line 215 does not resonate at any of the frequencies that are used in the dielectric-gapped electromagnetic conductive interconnect 200.

Second transmission member 216 is in electrical communication with secondary communications member 202. Second transmission member 216 includes a material that has a high electrical conductivity and a low dielectric constant to efficiently transmit electrical signals between secondary communications member 202 and secondary transceiver 220. In an embodiment, with reference to FIG. 11 to FIG. 13, second transmission member 216 includes first transmission signal line 214 disposed on dielectric layer 231 and first transmission ground line 215 disposed on dielectric layer 231, wherein dielectric layer 231 is interposed between first transmission signal line 214 and first transmission ground line 215 so that first transmission signal line 214 and first transmission ground line 215 are electrically isolated from one another. Second transmission member 216 has a low resistance in its electrically conductive portions, which minimizes power losses and can be include a variety of materials, including copper, silver, and gold along with suitable dielectric material to insulate electrically conductive members from one another. The material used for second transmission member 216 can depend on the specific application. For example, if the dielectric-gapped electromagnetic conductive interconnect 200 is used in a high-frequency application, then a material with a high electrical conductivity and a low dielectric constant, such as copper, can be used. Second transmission member 216 can be in a variety of shapes and sizes. The shape and size of second transmission member 216 can depend on the specific application. For example, if the dielectric-gapped electromagnetic conductive interconnect 200 is used in a small, portable device, then second transmission member 216 can be made small and thin. Exemplary second transmission members 216 include photodetectors, amplifiers, coaxial cables, and the like.

The second transmission signal line 217 is a conductive line that is disposed on dielectric layer 231. The second transmission signal line 217 is in electromagnetic communication with secondary signal line 210 and secondary transceiver 220. The second transmission signal line 217 is disposed on dielectric layer 231 such that it is spaced apart from second transmission ground line 218 by a dielectric gap or dielectric layer 231. The dielectric gap is a region of space that is filled with a dielectric material, such as air or a non-conductive polymer. The dielectric gap can electrically insulate the second transmission signal line 217 from second transmission ground line 218. The second transmission signal line 217 can be made of a conductive material, such as copper or aluminum. The conductive material of the second transmission signal line 217 is selected to have a high electrical conductivity and a low electrical resistance. The high electrical conductivity of the conductive material of the second transmission signal line 217 allows for the efficient transmission of electrical signals. The low electrical resistance of the conductive material of the second transmission signal line 217 minimizes the loss of electrical signals during transmission. The second transmission signal line 217 can have a length that is greater than the wavelength of the electrical signals that are being transmitted. The length of the second transmission signal line 217 is selected to ensure that the electrical signals are transmitted without significant attenuation. The attenuation of electrical signals is the loss of power or energy that occurs as the signals are transmitted. The attenuation of electrical signals is caused by a number of factors, including the resistance of the conductive material, the capacitance of the dielectric material, and the inductance of the conductive material. The second transmission signal line 217 has a cross-sectional area that is greater than the minimum cross-sectional area required to carry the electrical current. The cross-sectional area of the second transmission signal line 217 is selected to ensure that the electrical current is carried without significant heating. The heating of electrical current is caused by the resistance of the conductive material. The heating of electrical current can cause the conductive material to melt or vaporize. The second transmission signal line 217 is terminated at its ends with connectors or can be hard wired. The connectors are used to connect the second transmission signal line 217 to the secondary wireless communicator 208 and the secondary wired extension 209. The connectors are selected to have a low contact resistance and a high mechanical strength. The low contact resistance of the connectors minimizes the loss of electrical signals during transmission. The high mechanical strength of the connectors prevents the connectors from being damaged during handling or use.

The second transmission ground line 218 is a conductive line that is disposed on dielectric layer 231 and that is in electrical communication with secondary communications member 202 or secondary transceiver 220. The second transmission ground line 218 can provide a ground reference for second transmission member 216 and the secondary communications member 202 and to reduce electromagnetic interference. The second transmission ground line 218 can be made of a conductive material such as copper or aluminum. The second transmission ground line 218 can be a single conductor or a plurality of conductors. The second transmission ground line 218 can be disposed on dielectric layer 231 in a variety of ways, such as by being etched, printed, or deposited. The second transmission ground line 218 can have a variety of properties, such as a length, a width, a thickness, a material, and a resistance. The length of the second transmission ground line 218 can be selected to optimize the performance of the dielectric-gapped electromagnetic conductive interconnect 200. The width of the second transmission ground line 218 can be selected to optimize the performance of the dielectric-gapped electromagnetic conductive interconnect 200. The thickness of the second transmission ground line 218 can be selected to optimize the performance of the dielectric-gapped electromagnetic conductive interconnect 200. The material of the second transmission ground line 218 can be selected to optimize the performance of the dielectric-gapped electromagnetic conductive interconnect 200. The resistance of the second transmission ground line 218 can be selected to optimize the performance of the dielectric-gapped electromagnetic conductive interconnect 200.

The primary transceiver 219 is a wireless wired transceiver that is arranged in electromagnetic communication with the primary wired extension 205 and the primary signal line 206 via first transmission member 213. The primary transceiver 219 is configured to receive and transmit electromagnetic signals. It includes a receiver that is configured to receive first receive transceiver signal 226 from first transmission member 213, and a transmitter that is configured to transmit electromagnetic signals 225 to first transmission member 213. The primary transceiver 219 can include a controller that is configured to control the operation of the receiver and the transmitter. The primary transceiver 219 can be configured to communicate with a host device. The primary transceiver 219 can include a housing that encloses the receiver, the transmitter, and the controller. The housing can be made of a material that is resistant to electromagnetic interference. Primary transceiver 219 can include a connector that is configured to connect the primary transceiver 219 to the host device. The connector is made of a material that is resistant to electromagnetic interference. Primary transceiver 219 can transmit electrical signal or optical signals. Primary transceiver 219 can receive electrical signal or optical signals. Any suitable device can be primary transceiver 219 so long as it receives and transmits electromagnetic signals described herein.

Secondary transceiver 220 is a wireless wired transceiver that is arranged in electromagnetic communication with secondary wired extension 209 and secondary wireless communicator 208 via second transmission member 216. Secondary transceiver 220 is configured to receive and transmit electromagnetic signals. It includes a receiver that is configured to receive first receive transceiver signal 230 from second transmission member 216, and a transmitter that is configured to transmit second transmit transceiver signal 229 to second transmission member 216. Secondary transceiver 220 can include a controller that is configured to control the operation of the receiver and the transmitter. Secondary transceiver 220 can be configured to communicate with a host device. Secondary transceiver 220 can include a housing that encloses the receiver, the transmitter, and the controller. The housing can be made of a material that is resistant to electromagnetic interference. Secondary transceiver 220 can include a connector that is configured to connect Secondary transceiver 220 to the host device. The connector is made of a material that is resistant to electromagnetic interference. The secondary transceiver 220 is configured to operate in a variety of environments, including indoor and outdoor environments. Secondary transceiver 220 can transmit electrical signal or optical signals. Secondary transceiver 220 can receive electrical signal or optical signals. Any suitable device can be secondary transceiver 220 so long as it receives and transmits electromagnetic signals described herein.

The primary interconnect signal 221 is an alternating current electrical signal that is transmitted between the primary communications member 201 and the secondary communications member 202. The signal is transmitted through interstitial dielectric partition 212 of the dielectric-gapped electromagnetic conductive interconnect 200, which can include a primary signal line 206, a secondary signal line 210, and an interstitial dielectric partition 212. The primary signal line 206 is disposed on the primary communications member 201, and the secondary signal line 210 is disposed on the secondary communications member 202. The interstitial dielectric partition 212 is interposed between the primary signal line 206 and the secondary signal line 210, and electrically insulates the primary signal line 206 from the secondary signal line 210. The primary interconnect signal 221 can be a high-frequency signal, and the dielectric-gapped electromagnetic conductive interconnect 200 is designed to minimize signal attenuation and maximize signal transmission. The dielectric-gapped electromagnetic conductive interconnect 200 is also designed to be immune to electromagnetic interference. The primary interconnect signal 221 can transmit data between the primary communications member 201 and the secondary communications member 202. The data can be any type of data, such as text, images, video, arbitrary waveform digital data, analog data, control signals, and the like. The primary interconnect signal 221 can also be used to control devices, such as motors or valves.

Secondary interconnect signal 222 is an alternating current electrical signal that is transmitted between the primary communications member 201 and the secondary communications member 202. Secondary interconnect signal 222 is transmitted through interstitial dielectric partition 212 of the dielectric-gapped electromagnetic conductive interconnect 200, which can include a primary signal line 206, a secondary signal line 210, and an interstitial dielectric partition 212. The primary signal line 206 is disposed on the primary communications member 201, and the secondary signal line 210 is disposed on the secondary communications member 202. The interstitial dielectric partition 212 is interposed between the primary signal line 206 and the secondary signal line 210, and electrically insulates the primary signal line 206 from the secondary signal line 210. Secondary interconnect signal 222 can be a high-frequency signal, and the dielectric-gapped electromagnetic conductive interconnect 200 is designed to minimize signal attenuation and maximize signal transmission. The dielectric-gapped electromagnetic conductive interconnect 200 is also designed to be immune to electromagnetic interference. Secondary interconnect signal 222 can transmit data between the primary communications member 201 and the secondary communications member 202. The data can be any type of data, such as text, images, video, arbitrary waveform digital data, analog data, control signals, and the like. Secondary interconnect signal 222 can also be used to control devices, such as motors or valves.

The primary transmission signal 223 is an alternating current electrical signal that is transmitted from first transmission member 213 to primary wireless communicator 204 of primary communications member 201 and subsequently to the secondary wireless communicator 208 across the interstitial dielectric partition 212. The primary transmission signal 223 is a high-frequency signal that can be modulated with information to be transmitted. The modulation scheme used can be any type of modulation scheme that is suitable for high-frequency signals, such as amplitude modulation, frequency modulation, or phase modulation. The primary transmission signal 223 can have a selected frequency and a selected power. The primary transmission signal 223 is transmitted as primary interconnect signal 221 that is mediated by a resonance between primary wireless communicator 204 and secondary wireless communicator 208 in distributed wireless junction 203 that is tuned by junction length 232 and junction cross-sectional area 233. The primary transmission signal 223 is received by the secondary wireless communicator 208 and can be demodulated to recover the information that was transmitted. In an embodiment, primary transmission signal 223 is a waveform that is used directly with its amplitude, phase, duty cycle, or other properties or can be modified after receipt by secondary transceiver 220 as first receive transceiver signal 230. The signals can have a power from 1 aW to 1 kW. The signals can have a frequency from 1 nHz to 10 THz, and more specifically from 100 MHz to 3 THz. The types of signals can include repetitive signals, non-repetitive signals, and a mixture of repetitive and non-repetitive signals. The types of signals can include single-frequency and multi-frequency signals. The types of signals can include modulated and non-modulated signals. The types of modulation schemes include analog and digital modulation. The information carried by the signals envisioned can be classical or quantum information. The range of phases spans from negative infinity to positive infinity. The phases of different frequencies can be locked or unlocked from one another, or a mixture of phase-locked and non-phase-locked signals. The phases of signals can describe individual frequencies in the frequency domain, the envelope of a signal in the time domain, or a mixture of individual frequencies in the frequency domain and the envelope of a signal in the time domain.

The primary receive signal 224 is an electrical signal that is received by first transmission member 213 from primary communications member 201. The primary receive signal 224 can be a modulated signal that carries information, such as data or voice. The properties of the primary receive signal 224 include its amplitude, frequency, and phase. The amplitude of the primary receive signal 224 is the magnitude of the signal, and it is measured in volts. The frequency of the primary receive signal 224 is the number of times per second that the signal goes through a complete cycle, and it is measured in hertz. The phase of the primary receive signal 224 is the position of the signal relative to a reference point, and it is measured in radians. The primary receive signal 224 can be amplified and filtered after or before it is received by primary transceiver 219 as first receive transceiver signal 226. The signals can have a power from 1 aW to 1 kW. The signals can have a frequency from 1 nHz to 10 THz, and more specifically from 100 MHz to 3 THz. The types of signals can include repetitive signals, non-repetitive signals, and a mixture of repetitive and non-repetitive signals. The types of signals can include single-frequency and multi-frequency signals. The types of signals can include modulated and non-modulated signals. The types of modulation schemes include analog and digital modulation. The information carried by the signals envisioned can be classical or quantum information. The range of phases spans from negative infinity to positive infinity. The phases of different frequencies can be locked or unlocked from one another, or a mixture of phase-locked and non-phase-locked signals. The phases of signals can describe individual frequencies in the frequency domain, the envelope of a signal in the time domain, or a mixture of individual frequencies in the frequency domain and the envelope of a signal in the time domain.

The first transmit transceiver signal 225 is an electromagnetic signal that is transmitted from the primary transceiver 219 to the secondary transceiver 220 wirelessly via distributed wireless junction 203. First transmit transceiver signal 225 is generated by the primary transceiver 219 and is then transmitted through the dielectric-gapped electromagnetic conductive interconnect 200. The signal is received by the secondary transceiver 220 and can be processed by the secondary transceiver 220. The first transmit transceiver signal 225 is first received by first transmission member 213 and propagated from first transmission member 213 to primary communications member 201 as primary transmission signal 223. In an embodiment, first transmit transceiver signal 225 is an alternating current electrical signal. In an embodiment, first transmit transceiver signal 225 is a digital signal that can be represented by a series of binary digits, or bits, wherein each bit can be either a 0 or a 1, and the bits can be transmitted in a serial fashion, one bit after the other. In an embodiment, first transmit transceiver signal 225 is a modulated signal. Here, first transmit transceiver signal 225 can be modulated by a carrier frequency. The carrier frequency can be a sine wave that is used to carry the digital signal. The carrier frequency can be in the range of 100 MHz to 1 GHz. In an embodiment, first transmit transceiver signal 225 is a band-pass signal that can have a specific frequency range, e.g., in the range from 200 MHz to 2 GHz. The signals can have a power from 1 aW to 1 kW. The signals can have a frequency from 1 nHz to 10 THz, and more specifically from 100 MHz to 3 THz. The types of signals can include repetitive signals, non-repetitive signals, and a mixture of repetitive and non-repetitive signals. The types of signals can include single-frequency and multi-frequency signals. The types of signals can include modulated and non-modulated signals. The types of modulation schemes include analog and digital modulation. The information carried by the signals envisioned can be classical or quantum information. The range of phases spans from negative infinity to positive infinity. The phases of different frequencies can be locked or unlocked from one another, or a mixture of phase-locked and non-phase-locked signals. The phases of signals can describe individual frequencies in the frequency domain, the envelope of a signal in the time domain, or a mixture of individual frequencies in the frequency domain and the envelope of a signal in the time domain.

The first receive transceiver signal 226 is an electromagnetic signal that is received by the first transceiver 219 from second transmit transceiver signal 229 produced by secondary transceiver 220 and wirelessly communicated across distributed wireless junction 203 of dielectric-gapped electromagnetic conductive interconnect 200. First receive transceiver signal 226 is a result of the electromagnetic coupling between the primary communications member 201 and the secondary communications member 202. First receive transceiver signal 226 can have a frequency that is determined by the junction length 232 and the junction cross-sectional area 233. The signal also has an amplitude that is determined by the strength of the electromagnetic coupling between the primary communications member 201 and the secondary communications member 202. The first receive transceiver signal 226 can be used by or to control operation of the first transceiver 219. First receive transceiver signal 226 can be processed by the first transceiver 219 to extract information that is used to control the operation of the first transceiver 219. The information that is extracted from the first receive transceiver signal 226 can be used to control the frequency of the output signal of the first transceiver 219, the amplitude of the output signal of the first transceiver 219, or the phase of the output signal of the first transceiver 219. The first receive transceiver signal 226 can be used to monitor the operation of secondary transceiver 220. The signals can have a power from 1 aW to 1 kW. The signals can have a frequency from 1 nHz to 10 THz, and more specifically from 100 MHz to 3 THz. The types of signals can include repetitive signals, non-repetitive signals, and a mixture of repetitive and non-repetitive signals. The types of signals can include single-frequency and multi-frequency signals. The types of signals can include modulated and non-modulated signals. The types of modulation schemes include analog and digital modulation. The information carried by the signals envisioned can be classical or quantum information. The range of phases spans from negative infinity to positive infinity. The phases of different frequencies can be locked or unlocked from one another, or a mixture of phase-locked and non-phase-locked signals. The phases of signals can describe individual frequencies in the frequency domain, the envelope of a signal in the time domain, or a mixture of individual frequencies in the frequency domain and the envelope of a signal in the time domain.

Secondary transmission signal 227 is an alternating current electrical signal that is transmitted from second transmission member 216 to secondary wireless communicator 208 of secondary communications member 202 and subsequently to primary wireless communicator 204 across the interstitial dielectric partition 212. Secondary transmission signal 227 is a high-frequency signal that can be modulated with information to be transmitted. The modulation scheme used can be any type of modulation scheme that is suitable for high-frequency signals, such as amplitude modulation, frequency modulation, or phase modulation. Secondary transmission signal 227 has a frequency of at least 100 MHz and a power of at least 100 mW. Secondary transmission signal 227 is transmitted as secondary interconnect signal 222 that is mediated by a resonance between primary wireless communicator 204 and secondary wireless communicator 208 in distributed wireless junction 203 that is tuned by junction length 232 and junction cross-sectional area 233. Secondary transmission signal 227 is received by primary wireless communicator 204 and can be demodulated to recover the information that was transmitted. In an embodiment, secondary transmission signal 227 is a waveform that is used directly with its amplitude, phase, duty cycle, or other properties or can be modified after receipt by primary transceiver 219 as first receive transceiver signal 226. The signals can have a power from 1 aW to 1 kW. The signals can have a frequency from 1 nHz to 10 THz, and more specifically from 100 MHz to 3 THz. The types of signals can include repetitive signals, non-repetitive signals, and a mixture of repetitive and non-repetitive signals. The types of signals can include single-frequency and multi-frequency signals. The types of signals can include modulated and non-modulated signals. The types of modulation schemes include analog and digital modulation. The information carried by the signals envisioned can be classical or quantum information. The range of phases spans from negative infinity to positive infinity. The phases of different frequencies can be locked or unlocked from one another, or a mixture of phase-locked and non-phase-locked signals. The phases of signals can describe individual frequencies in the frequency domain, the envelope of a signal in the time domain, or a mixture of individual frequencies in the frequency domain and the envelope of a signal in the time domain.

The secondary receive signal 228 is an electrical signal that is received by second transmission member 216 from secondary communications member 202. The secondary receive signal 228 is produced by secondary communications member 202 when it receives the primary interconnect signal 221 from the primary signal line 206 of primary communications member 201. The secondary receive signal 228 can include modulated information that can be demodulated, e.g., second transmission member 216 or secondary transceiver 220 to recover the information that is carried by the primary interconnect signal 221. The secondary receive signal 228 has a frequency spectrum that can be centered around the frequency of the primary interconnect signal 221. Secondary receive signal 228 can be amplified and filtered after or before it is received by secondary transceiver 220 as first receive transceiver signal 230. The secondary receive signal 228 can be used to communicate information that can be used to control a device, to monitor a process, or to provide feedback. The secondary receive signal 228 can also be used to transmit data. The signals can have a power from 1 aW to 1 kW. The signals can have a frequency from 1 nHz to 10 THz, and more specifically from 100 MHz to 3 THz. The types of signals can include repetitive signals, non-repetitive signals, and a mixture of repetitive and non-repetitive signals. The types of signals can include single-frequency and multi-frequency signals. The types of signals can include modulated and non-modulated signals. The types of modulation schemes include analog and digital modulation. The information carried by the signals envisioned can be classical or quantum information. The range of phases spans from negative infinity to positive infinity. The phases of different frequencies can be locked or unlocked from one another, or a mixture of phase-locked and non-phase-locked signals. The phases of signals can describe individual frequencies in the frequency domain, the envelope of a signal in the time domain, or a mixture of individual frequencies in the frequency domain and the envelope of a signal in the time domain.

Second transmit transceiver signal 229 is an electromagnetic signal that is transmitted from secondary transceiver 220 to primary transceiver 219 wirelessly via distributed wireless junction 203. Second transmit transceiver signal 229 is generated by secondary transceiver 220 and is then transmitted through the dielectric-gapped electromagnetic conductive interconnect 200. The signal is received by primary transceiver 219 and can be processed by secondary transceiver 220. Second transmit transceiver signal 229 is first received by second transmission member 216 and propagated from second transmission member 216 to secondary communications member 202 as secondary transmission signal 227. In an embodiment, second transmit transceiver signal 229 is an alternating current electrical signal. In an embodiment, second transmit transceiver signal 229 is a digital signal that can be represented by a series of binary digits, or bits, wherein each bit can be either a 0 or a 1, and the bits can be transmitted in a serial fashion, one bit after the other. In an embodiment, second transmit transceiver signal 229 is a modulated signal. Here, second transmit transceiver signal 229 can be modulated by a carrier frequency. The carrier frequency can be a sine wave that is used to carry the digital signal. The carrier frequency can be in the range of 100 MHz to 1 GHz. In an embodiment, second transmit transceiver signal 229 is a band-pass signal that can have a specific frequency range, e.g., in the range from 200 MHz to 2 GHz. The signals can have a power from 1 aW to 1 kW. The signals can have a frequency from 1 nHz to 10 THz, and more specifically from 100 MHz to 3 THz. The types of signals can include repetitive signals, non-repetitive signals, and a mixture of repetitive and non-repetitive signals. The types of signals can include single-frequency and multi-frequency signals. The types of signals can include modulated and non-modulated signals. The types of modulation schemes include analog and digital modulation. The information carried by the signals envisioned can be classical or quantum information. The range of phases spans from negative infinity to positive infinity. The phases of different frequencies can be locked or unlocked from one another, or a mixture of phase-locked and non-phase-locked signals. The phases of signals can describe individual frequencies in the frequency domain, the envelope of a signal in the time domain, or a mixture of individual frequencies in the frequency domain and the envelope of a signal in the time domain.

First receive transceiver signal 230 is an electromagnetic signal that is received by secondary transceiver 220 from secondary receive signal 228 produced by primary transceiver 219 as first transmit transceiver signal 225 and wirelessly communicated across distributed wireless junction 203 of dielectric-gapped electromagnetic conductive interconnect 200 as primary interconnect signal 221. First receive transceiver signal 230 is a result of the electromagnetic coupling between the primary communications member 201 and the secondary communications member 202. First receive transceiver signal 230 can have a frequency that is determined by the junction length 232 and the junction cross-sectional area 233. First receive transceiver signal 230 also has an amplitude that is determined by the strength of the electromagnetic coupling between the primary communications member 201 and the secondary communications member 202. First receive transceiver signal 230 can be used by or to control operation of secondary transceiver 220. First receive transceiver signal 230 can be processed by secondary transceiver 220 to extract information that is used by or to control operation of secondary transceiver 220. In an embodiment, information extracted from first receive transceiver signal 230 can be used to control the frequency of the output signal of secondary transceiver 220, the amplitude of the output signal of secondary transceiver 220, or the phase of the output signal of secondary transceiver 220. First receive transceiver signal 230 can be used to monitor the operation of primary transceiver 219. The signals can have a power from 1 aW to 1 kW. The signals can have a frequency from 1 nHz to 10 THz, and more specifically from 100 MHz to 3 THz. The types of signals can include repetitive signals, non-repetitive signals, and a mixture of repetitive and non-repetitive signals. The types of signals can include single-frequency and multi-frequency signals. The types of signals can include modulated and non-modulated signals. The types of modulation schemes include analog and digital modulation. The information carried by the signals envisioned can be classical or quantum information. The range of phases spans from negative infinity to positive infinity. The phases of different frequencies can be locked or unlocked from one another, or a mixture of phase-locked and non-phase-locked signals. The phases of signals can describe individual frequencies in the frequency domain, the envelope of a signal in the time domain, or a mixture of individual frequencies in the frequency domain and the envelope of a signal in the time domain.

The dielectric layer 231 can be disposed on primary communications member 201 or secondary communications member 202 and electrically insulates primary communications member 201 or secondary communications member 202. The dielectric layer 231 can be made of a material that has a high dielectric constant, such as a ceramic, glass, polymer, and the like. A high dielectric constant material can be used to reduce the capacitance between the primary and secondary communications members to reduce the amount of energy that is lost as heat when an alternating current electrical signal is transmitted through the interconnect. The dielectric layer 231 can be made of a material that has a low loss tangent. The loss tangent of a material is a measure of how much energy is lost as heat when an alternating current electrical signal is transmitted through the material. A low loss tangent can be desirable for a dielectric layer in a dielectric-gapped electromagnetic conductive interconnect because it helps to reduce the amount of energy that is lost as heat. The dielectric layer 231 can be made of a material that is compatible with the materials used for the primary and secondary communications members to ensure that the dielectric layer will not degrade over time or react with the materials used for the primary and secondary communications members. The dielectric layer 231 can have an arbitrary thickness or shape designed for a variety of applications.

The junction length 232 is the linear length along primary signal line 206 in distributed wireless junction 203 that extends away from primary wireless communicator 204 into primary communications member 201. It is a parameter that can adjust performance of the dielectric-gapped electromagnetic conductive interconnect 200. The junction length 232 can be chosen to optimize the frequency response of distributed wireless junction 203 and to adjust the electromagnetic coupling between the primary and secondary communications members. The junction length 232 can be adjusted by changing the overlap length of primary signal line 206 and secondary signal line 210 in distributed wireless junction 203. The smaller the length, the shorter the junction length 232. The length of junction length 232 can be a suitable length to create a resonance condition for communicating primary interconnect signal 221 or secondary interconnect signal 222 across interstitial dielectric partition 212 in distributed wireless junction 203. Junction length 232 can be selected to optimize the performance of distributed wireless junction 203 or to maximize electromagnetic coupling between the primary and secondary communications members (201, 202).

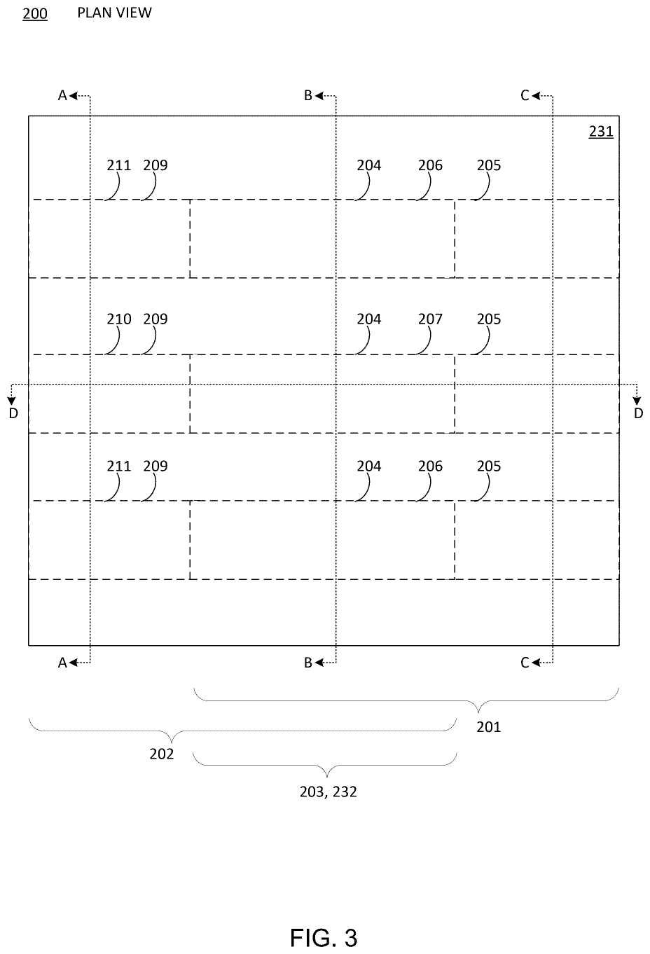

The junction cross-sectional area 233 is the area between the primary communications member 201 and the secondary communications member 202, as shown in FIG. 3. Junction cross-sectional area 233 can adjust performance of the dielectric-gapped electromagnetic conductive interconnect 200. Junction cross-sectional area 233 can be chosen to optimize the performance of distributed wireless junction 203 for electrically communicating an alternating current electrical signal (221 or 222). The junction cross-sectional area can be varied by changing the size of the primary and secondary communications members or the distance between them by changing the thickness of the interstitial dielectric partition 212.

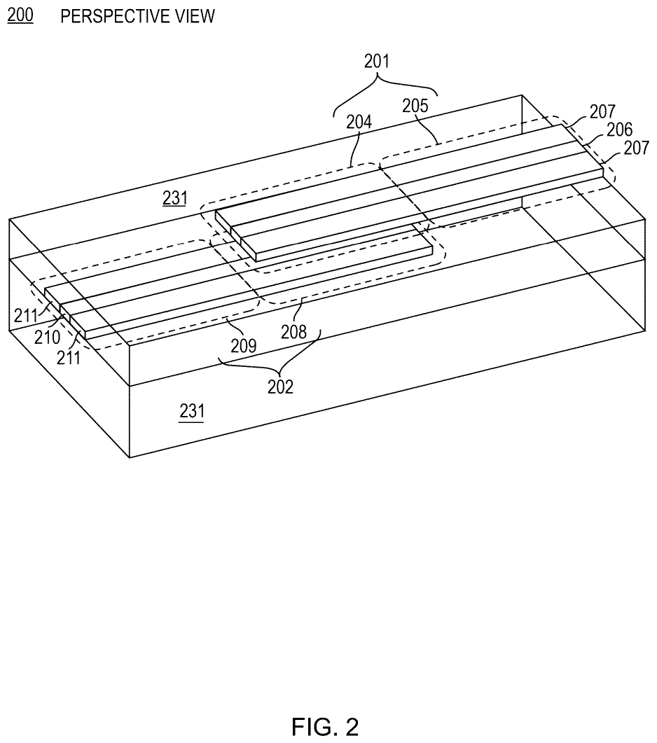

In an embodiment, distinct metal layers of a multilayer process are coupled, e.g., as shown in FIG. 2. A coplanar waveguide in a first layer (206) is coupled to a coplanar waveguide in a second layer (210) so that distributed wireless junction 203 is configured as a broadside coupled coplanar waveguide. The cross sectional geometries of components are design parameters to optimize coupling. The size of junction length 232 can be adjusted to tune the frequency response.

Dielectric-gapped electromagnetic conductive interconnect 200 can be made in various ways. It should be appreciated that dielectric-gapped electromagnetic conductive interconnect 200 includes a number of optical, electrical, or mechanical components, wherein such components can be interconnected and placed in communication (e.g., optical communication, electrical communication, mechanical communication, fluid communication, and the like) by physical, chemical, optical, or free-space interconnects. The components can be disposed on mounts that can be disposed on a bulkhead for alignment or physical compartmentalization. As a result, dielectric-gapped electromagnetic conductive interconnect 200 can be disposed in a terrestrial environment or space environment. Elements of dielectric-gapped electromagnetic conductive interconnect 200 can be formed from silicon, silicon nitride, and the like although other suitable materials, such as ceramic, glass, or metal can be used. According to an embodiment, the elements of dielectric-gapped electromagnetic conductive interconnect 200 are formed using 3D printing although the elements of dielectric-gapped electromagnetic conductive interconnect 200 can be formed using other methods, such as injection molding or machining a stock material such as block of material that is subjected to removal of material such as by cutting, laser oblation, and the like. Accordingly, dielectric-gapped electromagnetic conductive interconnect 200 can be made by additive or subtractive manufacturing. In an embodiment, elements of dielectric-gapped electromagnetic conductive interconnect 200 are selectively etched to remove various different materials using different etchants and photolithographic masks and procedures. The various layers thus formed can be subjected to joining by bonding to form dielectric-gapped electromagnetic conductive interconnect 200.

In an embodiment, a process for making dielectric-gapped electromagnetic conductive interconnect 200 includes: providing a first substrate; forming a first dielectric layer on the first substrate; providing a second substrate; forming a second dielectric layer on the second substrate; aligning and bonding together the first and second substrates and; forming a conductive layer on the first and second dielectric layers; patterning the conductive layer to form a plurality of conductive traces; connecting conductive traces to form a plurality of electrical connections; releasing the dielectric-gapped electromagnetic conductive interconnect 200 from the first and second substrates.

The process conditions for making and assembling the dielectric-gapped electromagnetic conductive interconnect 200 can vary depending on the specific materials and methods used. The first and second substrates independently can be made of a variety of materials, such as silicon, glass, or ceramic. The first dielectric layer can be made of a variety of materials, such as silicon dioxide, boron nitride, or aluminum oxide. The second dielectric layer can be made of a variety of materials, such as silicon dioxide, boron nitride, or aluminum oxide. The conductive layer can be made of a variety of materials, such as copper, gold, or silver. The conductive traces can be patterned using a variety of methods, such as photolithography, electron beam lithography, or ion beam lithography. The electrical connections can be formed using a variety of methods, such as soldering, welding, or bonding.

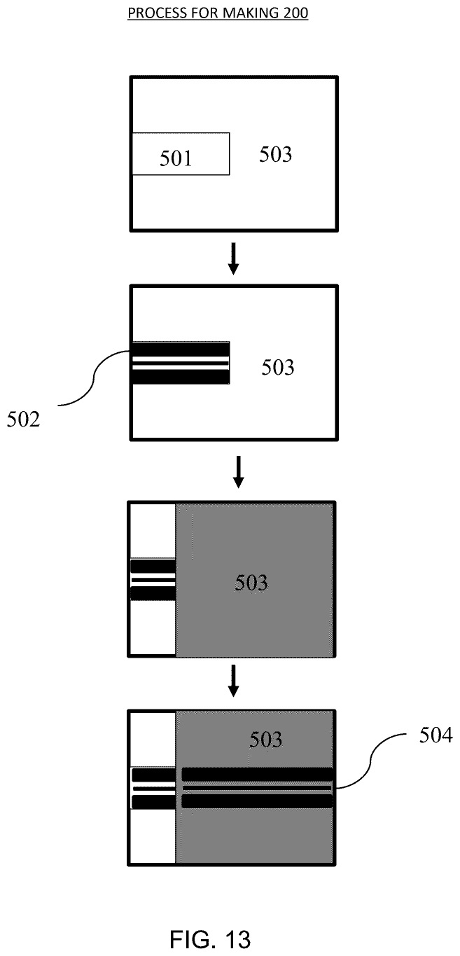

In an embodiment with reference to FIG. 13, a process for making dielectric-gapped electromagnetic conductive interconnect 200 includes patterning a dielectric footprint on a substrate. The footprint can includes a pocket where the transmission line is formed. A transmission line is formed in the pocket, wherein a thickness of the transmission line can be the same thickness as the dielectric footprint. A dielectric spacer layer is formed thereon such that the spacer layer provides a separation distance between each transmission line. A second transmission line is formed over the first transmission line and spaced apart from the first transmission line by the dielectric spacer layer to electrically insulate the second transmission line and the first transmission line.

Dielectric-gapped electromagnetic conductive interconnect 200 has numerous advantageous and unexpected benefits and uses. In an embodiment, a process for electrically communicating an alternating current electrical signal with dielectric-gapped electromagnetic conductive interconnect 200 includes: disposing a primary communications member on an interstitial dielectric partition; disposing a secondary communications member on the interstitial dielectric partition; disposing the primary communications member to the secondary communications member in electromagnetic communication via interstitial dielectric partition 212; communicating an alternating current electrical signal between the primary communications member and the secondary communications member; and receiving the alternating current electrical signal at the secondary communications member. In an embodiment, the primary communications member includes a primary wireless communicator, a primary wired extension, and a primary signal line. In an embodiment, the secondary communications member includes a secondary wireless communicator, a secondary wired extension, and a secondary signal line. In an embodiment, the primary signal line is disposed on the interstitial dielectric partition and in electromagnetic communication with the secondary signal line. In an embodiment, the primary signal line in the primary wireless communicator receives a secondary interconnect signal from the secondary signal line in the secondary wireless communicator across the interstitial dielectric partition. In an embodiment, the primary signal line in the primary wireless communicator produces a primary receive signal from the secondary interconnect signal. In an embodiment, the primary signal line in the primary wireless communicator receives a primary transmission signal. In an embodiment, the primary signal line in the primary wireless communicator produces a primary interconnect signal from the primary transmission signal. In an embodiment, the primary interconnect signal is communicated to the secondary signal line in the secondary wireless communicator. In an embodiment, the secondary signal line in the secondary wireless communicator receives the primary interconnect signal from the primary signal line in the primary wireless communicator across the interstitial dielectric partition. In an embodiment, the secondary signal line in the secondary wireless communicator produces a secondary receive signal from the primary interconnect signal. In an embodiment, the secondary signal line in the secondary wireless communicator receives a secondary transmission signal. In an embodiment, the secondary signal line in the secondary wireless communicator produces a secondary interconnect signal from the secondary transmission signal. In an embodiment, the secondary interconnect signal is communicated to the primary signal line in the primary wireless communicator. In an embodiment, the primary signal line in the primary wireless communicator receives the secondary interconnect signal from the secondary signal line in the secondary wireless communicator across the interstitial dielectric partition.

The dielectric-gapped electromagnetic conductive interconnect 200 of claim 10 can be used in a variety of applications, including but not limited to wireless communication systems, data transmission systems, power transmission systems, medical devices, industrial equipment, and the like.

In an embodiment, a process for electrically communicating an alternating current electrical signal with dielectric-gapped electromagnetic conductive interconnect 200 includes preparing the primary communications member 201 and the secondary communications member 202, e.g., cleaning the surfaces of the members, applying a primer, and applying a coating. The process can include assembling the primary communications member 201 and the secondary communications member 202, e.g., by disposing the members proximate to each other with an intervening interstitial dielectric partition 212, applying a pressure to the members, and curing any adhesive used to join the members. The process can include applying the dielectric layer 231 to the primary communications member 201 and the secondary communications member 202, e.g., by spraying, brushing, or rolling the dielectric layer onto the members. The process can include curing the dielectric layer 231, e.g., by baking, curing, or using a UV light. The process can include testing the dielectric-gapped electromagnetic conductive interconnect 200 by testing the electrical conductivity, the mechanical strength, and the environmental resistance of dielectric-gapped electromagnetic conductive interconnect 200.

Various configurations are contemplated. In an embodiment, the source and receiver are on separate chips, wherein the source or receiver can themselves be transmission lines. Here, the output transmission line of the source is disposed in the vicinity of the input transmission line of the receiver. Both transmission lines be parallel. The separation distance between both transmission lines is adjusted to tune the transmission of the interconnect. The coupling length can be changed to tune the frequency response.

In an embodiment, the source and receiver are in separate metal layers of a multilayer fabrication process, wherein the output transmission line of the source is proximate to the input transmission line of the receiver. Both transmission lines can be parallel to one another. The separation distance between both transmission lines can be changed to tune the transmission of the interconnect. The coupling length can be changed to tune the frequency response.

In an embodiment, dielectric-gapped electromagnetic conductive interconnect 200 and electrically communicating an alternating current electrical signal can include the properties, functionality, hardware, and process steps described herein and embodied in any of the following non-exhaustive list:
a process (e.g., a computer-implemented method including various steps; or a method carried out by a computer including various steps);
an apparatus, device, or system (e.g., a data processing apparatus, device, or system including means for carrying out such various steps of the process; a data processing apparatus, device, or system including means for carrying out various steps; a data processing apparatus, device, or system including a processor adapted to or configured to perform such various steps of the process);
a computer program product (e.g., a computer program product including instructions which, when the program is executed by a computer, cause the computer to carry out such various steps of the process; a computer program product including instructions which, when the program is executed by a computer, cause the computer to carry out various steps);
a computer-readable storage medium or data carrier (e.g., a computer-readable storage medium including instructions which, when executed by a computer, cause the computer to carry out such various steps of the process; a computer-readable storage medium including instructions which, when executed by a computer, cause the computer to carry out various steps; a computer-readable data carrier having stored thereon the computer program product; a data carrier signal carrying the computer program product); a computer program product including comprising instructions which, when the program is executed by a first computer, cause the first computer to encode data by performing certain steps and to transmit the encoded data to a second computer; or
a computer program product including instructions which, when the program is executed by a second computer, cause the second computer to receive encoded data from a first computer and decode the received data by performing certain steps.

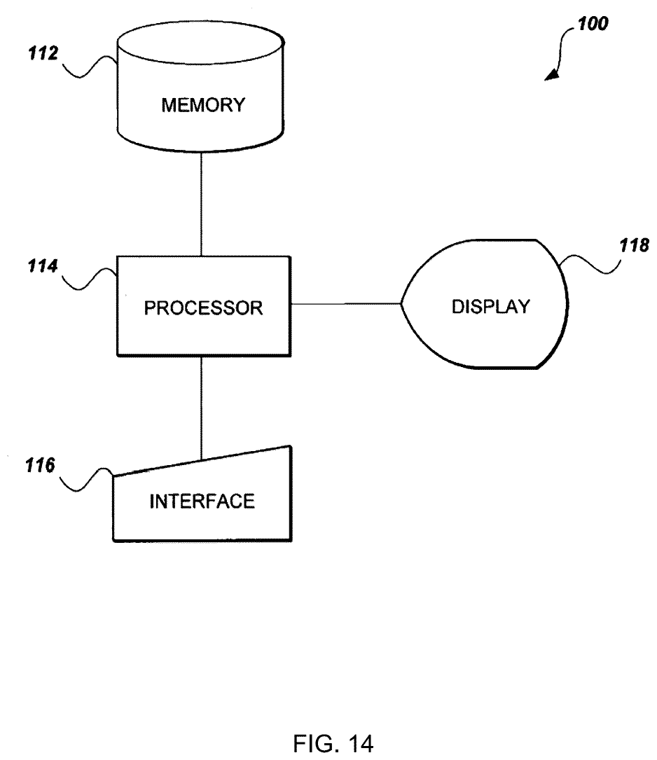

It should be understood that the calculations can be performed by any suitable computer system, such as that diagrammatically shown in FIG. 14. Data is entered into system 100 via any suitable type of user interface 116, and can be stored in memory 112, which can be any suitable type of computer readable and programmable memory and is preferably a non-transitory, computer readable storage medium. Calculations are performed by processor 114, which can be any suitable type of computer processor and can be displayed to the user on display 118, which can be any suitable type of computer display. Processor 114 can be associated with, or incorporated into, any suitable type of computing device, for example, a personal computer or a programmable logic controller. The display 118, the processor 114, the memory 112 and any associated computer readable recording media are in communication with one another by any suitable type of data bus, as is well known in the art. Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that can be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable media include all computer-readable media except for a transitory, propagating signal.

The dielectric-gapped electromagnetic conductive interconnect 200 has the advantage of providing a more efficient and reliable way to communicate an alternating current electrical signal. Dielectric-gapped electromagnetic conductive interconnect 200 can have an improved the signal-to-noise ratio and reduce the likelihood of errors in the transmitted signal compared with wired electrical communications. The dielectric layer 231 can help protect the interconnect from damage from moisture and other environmental factors. This can extend the life of the interconnect and make it more reliable in harsh environments.

The articles and processes herein are illustrated further by the following Examples, which are non-limiting.

### EXAMPLES

### Example 1. Distributed Contactless Interconnects for Millimeter-Wave Heterogeneous Integration

Conventional integrated circuits leverage dissimilar materials to optimize system performance. Such heterogeneous integration often involves multiple chips electrically coupled to one another via bump bonds or wire-bond interconnects. While these interconnects are a mature technology for low-frequency operation (<100 GHz), they have stringent fabrication requirements and are prone to failure during operation in the terahertz range (300 GHz to 10 THz). Next-generation integrated circuits require alternative interconnect topologies that are less sensitive to fabrication tolerances and conditions, are more robust, and have superior high-frequency performance. Here, we demonstrate distributed coupling to 325 GHz between broadside-coupled coplanar waveguides without bump bonds, wire bonds, or direct metal-to-metal bonding. The insertion loss of these contactless interconnects was approximately 1.4 dB at the maximum in the passbands at 63 GHz, 93 GHz, and 120 GHz. This interconnect topology enables robust integration of low-cost silicon with high-speed compound semiconductors for terahertz communications networks to improve reliability and increase yield.

Heterogeneous integration enables millimeter-wave (mmWave) and terahertz wireless communication technology by allowing designers to balance cost and performance trade-offs between conventional, cheaper silicon integrated circuits and faster, more expensive compound-semiconductor integrated circuits. Heterogeneous integration directly connects electrodes of integrated circuits from different technologies and allows alternating (ac) and direct (dc) currents to pass between devices. Typical mmWave integrated circuits use dozens of contact interconnects that directly connect the electrodes between chips and integration boards.

There are several types of contact interconnects, including wire bonds, bump bonds, and metal-to-metal bonds. Each type of contact interconnect has different advantages for specific applications. For example, metal-to-metal bonds have the shortest length, which makes them ideal for operation at mmWave frequencies where the electrical length of the interconnect can impact device performance. However, contact interconnects can fail when there is a break or defect in the electrical contact between the bonded electrodes. To avoid failure, fabrication engineers sometimes use specialized surface treatments and ultra-low particle count cleanrooms to improve the yield of contact interconnects. These additional steps add cost and time to the production of integrated circuits.

Alternatively, contactless interconnects propagate an ac signal between electrodes that are not in direct electrical contact. Contactless interconnects may use lumped or distributed coupling. In the distributed case, transmission lines couple over a length l_{c} (FIG. 14). Example 2 provides an analytical framework for designing distributed contactless interconnects and applied our approach to broadside-coupled coplanar waveguides.

A distributed contactless interconnect uses monolithic fabrication to precisely control alignment and to provide an idealized test case. We compare the measured scattering (S−) parameters to the predicted performance that inspired this work and conclude that distributed contactless interconnects can transmit mmWave signals with approximately 1.4 dB of loss in the passbands at 63 GHz, 93 GHz, and 120 GHz.

### Design and Fabrication.

Our interconnect test structure (FIG. 14) includes three coplanar waveguides (CPWs) separated from each other by an SU-8 spacer layer. Together, these CPWs form a series of distinct regions. Between Probe 1 and Probe 2, the structure is nominally symmetric. Region 1 is a CPW of length 210 μm with air above and fused silica below. Region 2 is a CPW of length 210 μm encapsulated by the 2.5 μm thick SU-8 spacer layer. Region IC contains our contactless interconnect. In this region, CPW 3 is broadside coupled to CPW 1 or CPW 2. Region 3 contains the portion of CPW 3 that is not broadside coupled to CPW 1 or CPW 2. Region 3 is 420 μm long and transmits electrical signals between the two interconnects contained by Regions IC. The length l_{c} of the interconnect regions determines the center frequency and bandwidth of the interconnect and, in this study, is either 500 μm, 250 μm, or 125 μm. The cross-sectional geometries of each region are displayed in Table 1 and were optimized for transmission through the entire device when measured with a reference impedance of 50Ω.

TABLE 1
Cross-sectional geometries for region 1, 2, 3, and Ic.

| Width (μm) | Region 1 | Region 2 | Region IC | Region 3 |
|---|---|---|---|---|
| Center | 30.0 | 28.0 | 30.0 | 33.0 |
| conductor | | | | |
| Gap | 3.0 | 4.0 | 5.0 | 3.0 |
| Ground plane | 50.0 | 50.0 | 48.0 | 48.5 |

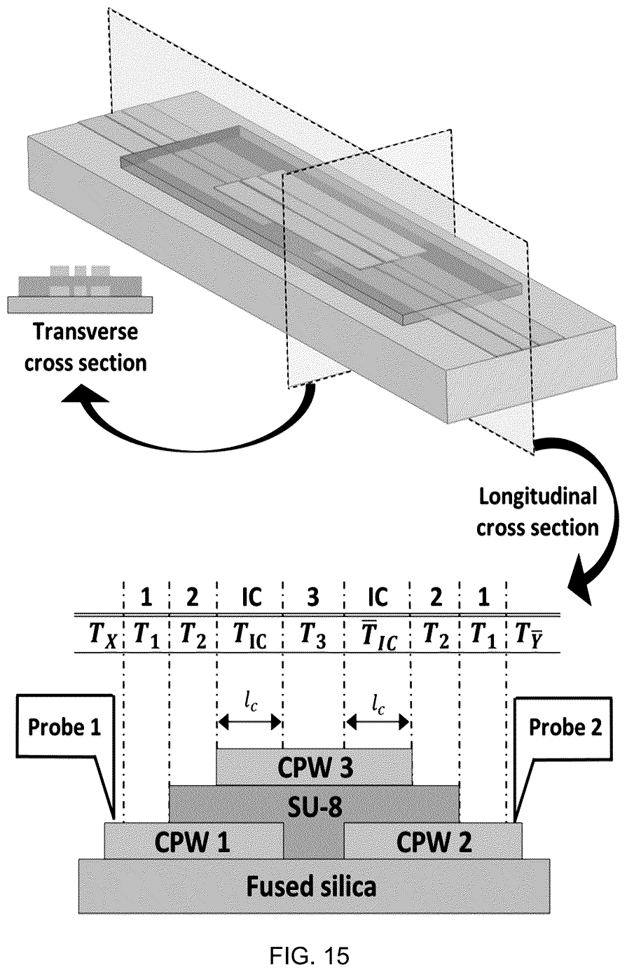

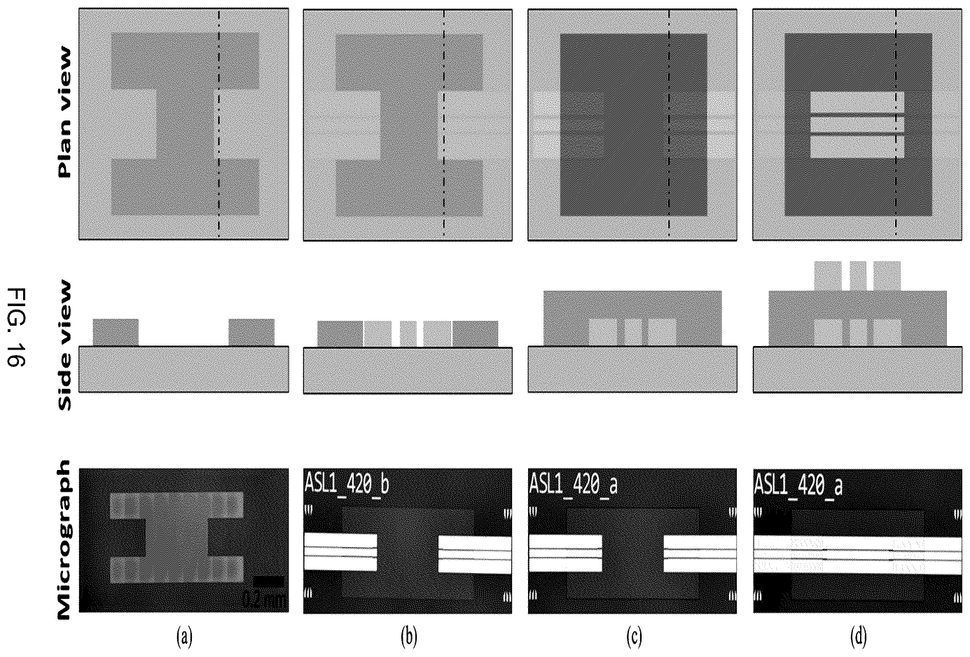

We fabricated our interconnect test structure in four monolithic layers: a 665 nm thick SU-8 layer, a 665 nm thick bottom Au conductor layer, a 2.5 μm thick SU-8 layer, and a 500 nm thick top Au layer. Both Au layers include a 10 nm thick Ti adhesion layer. First, we fabricated a thin SU-8 footprint (FIG. 16(a)) by spinning thinned SU-8 2002 at a rotational speed of 3000 rpm. Next, we used a conventional lift-off resist process and electron beam evaporation to deposit an Au layer of the same thickness in the SU-8 pockets (FIG. 16(b)). We used a quartz crystal monitor to measure the thickness of the Au layer during deposition. Matching the thickness of the first two layers ensured that the subsequent SU-8 spacer layer was qualitatively flat (FIG. 15(c)). We fabricated the next layer, the 2.5 μm thick SU-8 layer, by spinning SU-8 2002 at a rotational speed of 2000 rpm. Each of the SU-8 layers used typical exposure and develop processes. We then patterned and deposited the final 500 nm thick Au layer on top of the SU-8, using the same lithography and deposition steps mentioned earlier (FIG. 15(d)). Image processing tools verified that all features had relative alignments within 1 μm.

### Measurement

We used three different VNA setups for this experiment. For measurements from dc to 110 GHz, we used a VNA with mmWave extensions to 110 GHz. We used 50 μm pitch ground-signal-ground (GSG) probes with 1 mm coaxial connectors on a manual microwave probe station. For measurements above 110 GHz, we used a different VNA with WR-5 and WR-3 extension modules, covering 140 GHz to 220 GHz and 220 GHz to 325 GHz, respectively. These measurements used 50 μm pitch GSG waveguide probes on an automated probe station. All measurement bands used a combination of an mTRL calibration and a series resistor calibration of Region 1 to correct the data to 50Ω. This calibration translated the reported measurement reference plane from the probe tips to the boundary between Region 1 and Region 2 (FIG. 25, bottom).

The transfer (T−) matrix model of the full test structure is the matrix product T_{X} T₁ T₂ T_{IC} T₃ T̅_{IC} T₂ T₁ T_{Y̅} (FIG. 25, bottom). An on-wafer mTRL calibration removes T_{X}, T_{Y̅}, and T₁. The corrected T-matrix model is then M_{C}=T₂ T_{IC} T₃ T̅_{IC} T₂, which is set to a reference impedance of 50Ω. Due to the symmetry of this matrix model, the insertion loss of a single interconnect can be approximated as the reported insertion loss divided by two. All reported full-wave simulations and measured S-parameters have the form of M_{C} (FIG. 16). The simulations and measurements agreed over the entire measurement bandwidth up to 325 GHz for each test structure.

We measured the S-parameters of three interconnect test structures with coupling lengths l_{c} equal to 500 μm, 250 μm, and 125 μm (FIG. 16 top, middle, and bottom rows, respectively). At low frequencies, the interconnect responds as a de block because there is no do connection between the bottom Au layer and the top Au layer. As frequency increases, the transmission (FIG. 16(a)) through each device increases, reaching a maximum at a frequency f₁. As frequency increases beyond f₁, the transmission of each interconnect decreases until it reaches a minimum at approximately −15 dB. This periodic alternation between transmission maxima at f and transmission minima continues, dividing the measurement into a series of transmission bands. We define the bandwidth of the nth transmission band, Δfₙ, as the frequency distance separating opposing points of 6 dB insertion loss below the transmission maximum. This 6 dB approximation corresponds to the full width at half max, or 3 dB of loss, for an individual interconnect.

Table 2 summarizes the performance of the interconnects as a function of l_{c}. The results from this work show good agreement with the predicted performance. The disagreements in the insertion loss and passband maxima are primarily due to the back-to-back nature of our test structure. De-embedding the interconnect (T_{IC}) from the measurement model (M_{C}) should improve agreement between the predicted response and the measured data.

TABLE 2
Interconnect performance comparison are multiplied by 2 because
two interconnects are arranged in a back-to-back configuration.

| | | | 6 dB bandwidth | | Insertion | |
|---|---|---|---|---|---|---|
| | Passband | | (FWHM), Δfₙ (GHz) | | loss, −S₂₁(fₙ) (dB) | |
| l_{c} | max, | | This | | This | |
| (μm) | fₙ (GHz) | | Work | Ref* | Work | Ref* |
| 500 | f₁ | 63 | 140 | 137 | 1.4 | 1.2 |
| | f₂ | 215 | 135 | 133 | 3.2 | 2.0 |
| 250 | f₁ | 93 | 260 | 274 | 1.3 | 1.0 |
| 125 | f₁ | 120 | >250 | 547 | 1.3 | 0.4 |

To demonstrate the practicality of coupled-line interconnects formed by a flip-chip process in a manufacturing environment, we performed a full-wave sensitivity analysis of the transmission, S_{IC,12}, for the interconnect with l_{c}=250 μm at its design frequency of 160 GHz. We varied four design variables: misalignment along the longitudinal axis (±3 μm), misalignment along the transverse axis (±3 μm), rotational misalignment (±0.5°) and thickness of the SU-8 (±300 nm). Surprisingly, S_{IC,12} was relatively insensitive to these variables and changed no more than-0.5 dB. This analysis suggests that these coupled-line interconnects are robust within realistic fabrication tolerances.

This Example provides tests on distributed contactless interconnects that transmit ac signals with low insertion loss over a broad bandwidth. Here, we designed distributed contactless interconnects to 325 GHz. We measured a minimum insertion loss of approximately 1.4 dB at the maximum in the passbands at 63 GHz, 93 GHz, and 120 GHz. Conventional interconnects fail when the contact breaks or there is a defect in the bond. Surface treatments and ultra-clean spaces can improve yield, but reducing dependence on these mitigation steps could decrease costs. As an alternative to contact interconnects, the distributed contactless interconnects described here can reduce the total number of contact bonding sites and minimize the points of failure, providing increased yield at lower cost.

### Example 2. A Distributed Theory for Contactless Interconnects at Terahertz Frequencies

Here we describe a multimodal model for distributed contactless interconnects by comparing it to 3D full-wave simulations. In comparison to 3D simulations, the model offers insight into how the interconnect works and reduces the computational cost of estimating the interconnect's performance. The performance of four distributed contactless interconnects have good agreement between our multimodal model and 3D simulations up to 1 THz. All the interconnects have less than 1 dB insertion loss in their first pass bands, highlighting the opportunity offered by contactless interconnects.

Contactless interconnects pass alternating current (ac) signals without direct electrical contact between electrodes that are separated by a dielectric layer. Distributed contactless interconnects can have lower insertion loss and can operate at higher frequencies than their lumped-element counterparts, yet there are few reports developing the theory for distributed contactless interconnects.

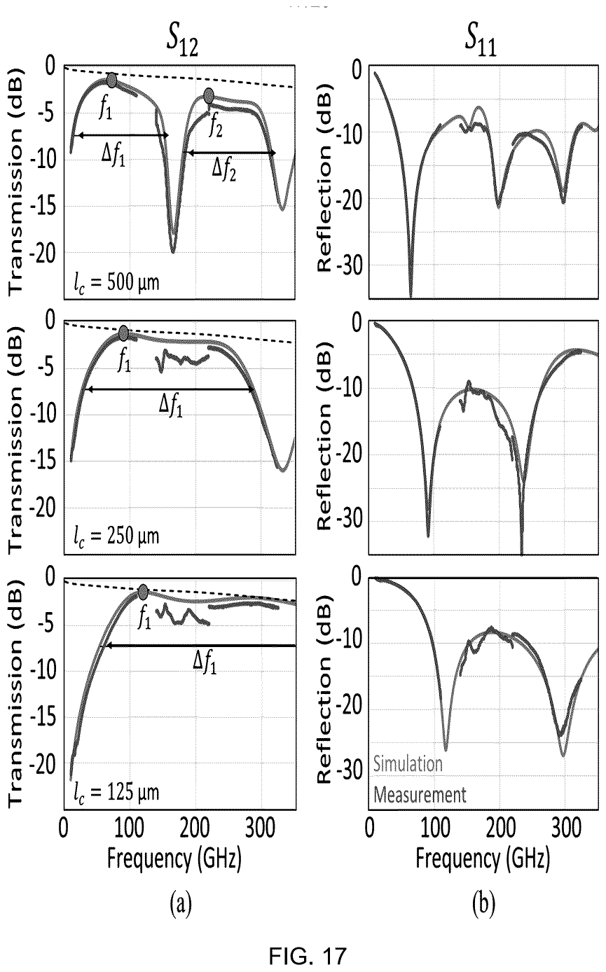

We explore a theory for distributed contactless interconnects that treats the problem as voltages and currents propagating along N coupled transmission lines. Our approach contains no fitting parameters and only requires that we specify 2N boundary conditions and know the geometry and electrical properties in each layer. To test our model, we designed distributed contactless interconnects with broadside-coupled coplanar waveguides (CPWs) separated by an SU-8 buffer layer (FIG. 17(a)). We then compared the scattering (S−) parameters predicted by our model to those obtained from full-wave simulations from dc to 1 THz.

### Theory

When two parallel signal lines with a shared ground are brought near one another, they form a dual-mode waveguide. The modes of this dual-mode waveguide are linear combinations of the modes of each single-mode waveguide, and the voltage and current waves of each mode travel with identical propagation constants. In a two-mode system and in the absence of terminations, these modes are decoupled from one another such that energy propagating in the first mode cannot be transferred to the second mode, and vice versa. More generally, in the quasistatic limit, N coupled lines will support N distinct propagation modes.

### Analytical Model for N-Coupled Transmission Lines

Consider N+1 independent conductors, each with a constant cross-section along the z-direction. If we select one conductor as a ground reference, we may define a unique voltage V_{ci} and current I_{ci} at position z along the ith conductor. Then, the conductor-representation vectors V_{c}(z)=(V_{c1}, V_{c2}, . . . , V_{cN})^{T} and I_{c}(z)=(I_{c1}, I_{c2}, . . . , I_{cN})^{T} completely characterize our system of N transmission lines. For a linear system in sinusoidal steady-state, these current and voltage vectors obey:

$$\frac{{dV}_{c}}{dz} = - {Z}_{c} {I}_{c} \qquad ( 1 )$$

$$and$$

$$\frac{{dI}_{c}}{dz} = - {Y}_{c} {V}_{c} . \qquad ( 2 )$$

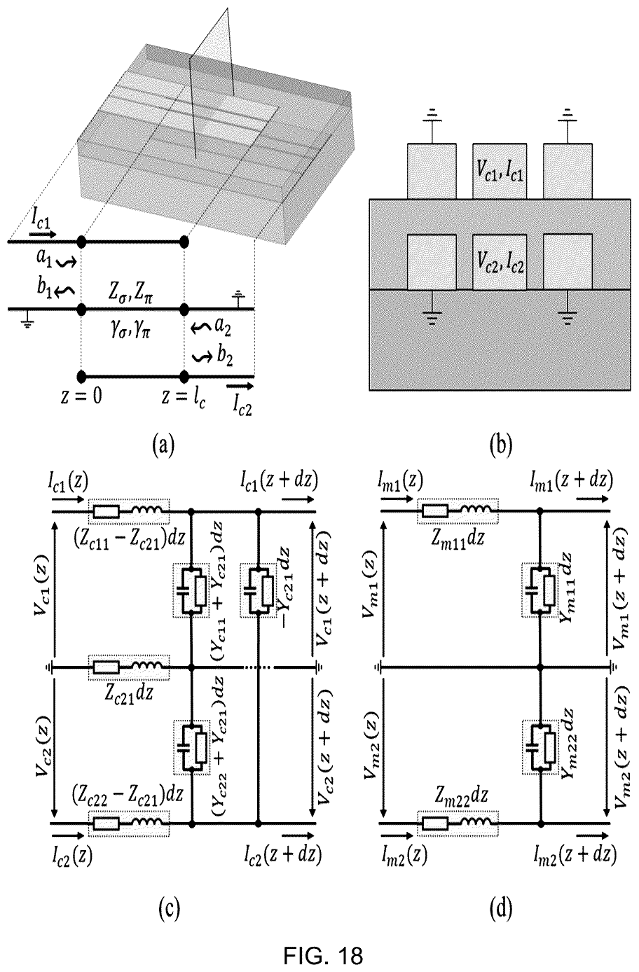

Here, Z_{c} and Y_{c} are the complex N×N matrices of conductor impedance and admittance per unit length, respectively. For our model, we calculate Z_{c}=R_{c}+iωL_{c} and Y_{c}=G_{c}+iωC_{c} by simulating the two-dimensional cross-section of the coupled lines (FIG. 18(b)) at angular frequency ω and computing the conductor-representation resistance (R_{c}), inductance (L_{c}), conductance (G_{c}), and capacitance (C_{c}) per unit length.

The Z_{c} and Y_{c} matrices are generally non-diagonal, meaning the voltage and current on each conductor do not travel in unison or with equal amplitudes (N=2, FIG. 18(c)). We now introduce the modal-representation voltage Vₘ and current Iₘ that are related to the conductor-representation via a basis transformation:

$${V}_{c} = {M}_{V} {V}_{m} \qquad ( 3 )$$

$$and$$

$${I}_{c} = {M}_{I} {I}_{m} . \qquad ( 4 )$$

Here, M_{V} and M_{I} are the unitless matrices that diagonalize Z_{c}Y_{c} and Y_{c}Z_{c}, respectively. In the modal basis, both the modal-impedance matrix

$${Z}_{m} = {M}_{V}^{- 1} {Z}_{c} {M}_{I}$$

and modal-admittance matrix

$${Y}_{m} = {M}_{I}^{- 1} {Y}_{c} {M}_{V}$$

are diagonal, so the voltage (V_{m,i}) and current (I_{m,i}) of the ith mode travel with the same propagation constant Y_{m,i}=\sqrt{Z_{m,ii}Y_{m,ii}}, and the ratio of the modal-impedance and modal-admittance matrices is the characteristic impedance Z_{m,i}=\sqrt{Z_{m,ii}/Y_{m,ii}} (modal representation for N=2, FIG. 18(d)).

The general solution when N=2 is:

$${V}_{c} ( z ) = {M}_{V} ( \begin{matrix}{Z}_{σ} {e}^{{γ}_{σ} z} & {Z}_{σ} {e}^{- {γ}_{Sσ} z} & 0 & 0 \\ 0 & 0 & {Z}_{π} {e}^{{γ}_{π} z} & {Z}_{π} {e}^{- {γ}_{π} z}\end{matrix} ) {ψ}_{4} \qquad ( 5 )$$

$$and$$

$${I}_{c} ( z ) = {M}_{I} ( \begin{matrix}- {e}^{{γ}_{σ} z} & {e}^{- {γ}_{σ} z} & 0 & 0 \\ 0 & 0 & - {e}^{{γ}_{π} z} & {e}^{- {γ}_{π} z}\end{matrix} ) {ψ}_{4} . \qquad ( 6 )$$

The state vector ψ₄ is a 4-dimensional vector whose elements represent the amplitude and phase of the backward- and forward-traveling voltage and current waves of each mode. Any value of ψ₄ is physically realizable and ψ₄ fully describes the voltage and current distribution along each conductor. The σ and π subscripts denote the mode in which the conductor voltages are in phase and out of phase, respectively. Next, we impose four boundary conditions to determine ψ₄.

### Boundary Conditions for Broadside-Coupled CPWs

To model the a and b waves at each port (FIG. 18(a), network model), we assume continuity of the voltage and current across the boundaries at z=0 (port 1) and z=l_{c} (port 2). At port 1, we define

$${( \begin{matrix}{a}_{1} \\ {b}_{1}\end{matrix} ) = \frac{\sqrt{Re ( {z}_{{R}_{1}} )}}{2 \vert {z}_{{R}_{1}} \vert} ( \begin{matrix}1 & {Z}_{{R}_{1}} \\ 1 & - {Z}_{{R}_{1}}\end{matrix} ) ( \begin{matrix}{V}_{c 1} \\ {I}_{c 1}\end{matrix} ) \vert}_{z = 0} . \qquad ( 7 )$$

At port 2, we define

$${( \begin{matrix}{a}_{2} \\ {b}_{2}\end{matrix} ) = \frac{\sqrt{Re ( {z}_{{R}_{2}} )}}{2 \vert {z}_{{R}_{2}} \vert} ( \begin{matrix}1 & - {Z}_{{R}_{2}} \\ 1 & {Z}_{{R}_{2}}\end{matrix} ) ( \begin{matrix}{V}_{c 2} \\ {I}_{c 2}\end{matrix} ) \vert}_{z = {l}_{c}} . \qquad ( 8 )$$

Lastly, we define the scattering matrix S as

$$S ( {Z}_{{R}_{1}} , {Z}_{{R}_{2}} ) = ( \begin{matrix}{\frac{{b}_{1}}{{a}_{1}} \vert}_{{a}_{2} = 0} & {\frac{{b}_{1}}{{a}_{2}} \vert}_{{a}_{1} = 0} \\ {\frac{{b}_{2}}{{a}_{1}} \vert}_{{a}_{2} = 0} & {\frac{{b}_{2}}{{a}_{2}} \vert}_{{a}_{1} = 0}\end{matrix} ) . \qquad ( 9 )$$

In Equations (7)-(9), the reference impedance at port i, Z_{R}_{ᵢ}, may be any complex value if its real part is positive. In this work, we use a reference impedance of Z_{R}_{₁}=Z_{R}_{₂}=50Ω.

To calculate S₁₁ and S₂₁ we impose the following boundary conditions to determine ψ₄:

$${a}_{1} = 1 V {Ω}^{- 1 / 2} \qquad ( 10 )$$

$${a}_{2} = 0 V {Ω}^{- 1 / 2} \qquad ( 11 )$$

$${I}_{c 1} ( z = {l}_{c} ) = 0 A \qquad ( 12 )$$

$${I}_{c 2} ( z = 0 ) = 0 A \qquad ( 13 )$$

Equations (10) and (11) indicate that an a-wave of unit magnitude is incident on port 1 from a transmission line with characteristic impedance of 50Ω and that there is no complementary a wave incident on port 2. Equations (12) and (13) assume an ideal, open-circuit termination on the open ends of both CPWs. To compute S₂₂ and S₁₂ we excite port 2 rather than port 1 by interchanging the effects of boundary conditions (10) and (11) on a₁ and a₂. Comparing the ideal-open model (boundary conditions (12) and (13)) with full-wave simulations indicates that the primary effect of fringing fields is to increase the effective length of the interconnect.

Simulations. Three-Dimensional Full-Wave Simulations.

We performed full-wave simulations of our distributed contactless interconnect with 3D High-Frequency Structure Simulator (HFSS). We used the default material properties in HFSS for the Au CPWs, ϵ=3.82 for the lossless fused silica substrate, and a frequency-dependent Cole-Cole permittivity model for the SU-8. All full-wave simulations used a multi-frequency adaptive mesh convergence criterion with 10 equally spaced frequency points between 100 GHz and 1 THz. The interconnect geometry used in this work was selected to maximize transmission and includes a 30 μm center conductor width, 5 μm gap width, 50 μm ground plane width, 500 nm Au thickness, and 3 μm SU-8 thickness. For each passband, we report the simulated maximum frequency (fₙ), width (Δfₙ), insertion loss (S₂₁(fₙ)), and return loss (S₁₁(fₙ)) in Table 3.

TABLE 3
Interconnect characterization.

| | Passband | | 3 dB bandwidth | Insertion | Return |
|---|---|---|---|---|---|
| l_{c} | maximum, | | (FWHM), | loss, −S₂₁(fₙ) | loss, −S₁₁(fₙ) |
| (μm) | fₙ (GHz) | | Δfₙ (GHz) | (dB) | (dB) |
| 500 | f₁ | 75 | 137 | 0.6 | 12.9 |
| | f₂ | 250 | 133 | 1.0 | 11.2 |
| 250 | f₁ | 160 | 274 | 0.5 | 13.0 |
| | f₂ | 495 | 276 | 0.6 | 10.0 |
| 125 | f₁ | 330 | 547 | 0.2 | 12.6 |
| | f₂ | 905 | >300 | 0.7 | 10.8 |
| 60 | f₁ | 510 | >900 | 0.1 | 11.5 |

### Two-Dimensional Cross-Sectional Simulations

We performed simulations of the interconnect cross-section (FIG. 17(b)) using 2D Extractor (ANSYS). These 2D simulations used the same geometry and materials properties for the interconnect cross-section as our 3D simulations. We modeled all CPW ground planes as grounded at the millimeter-wave frequencies of interest. A three-mode 2D simulation (not shown) improved our model's performance at low frequencies where electromagnetic coupling did not fully ground the top CPW.

Our 2D simulations compute the conductor-representation distributed matrix parameters R_{c}, L_{c}, G_{c}, and C_{c} (FIG. 18), producing a few noteworthy results. First, the off-diagonal terms (black curves) were nonzero, indicating coupling between the stacked CPWs. Second, the diagonal elements of R_{c} and L_{c} (FIGS. 18(a) and (b)) were identical, but the diagonal elements of G_{c} and C_{c} (FIGS. 18(c) and (d)) were not. This observation was consistent with our expectation that R_{c} and L_{c} only depend on conductor geometry, which was identical for each CPW, whereas G_{c} and C_{c} depend also on the dielectric environment, which was not identical for each CPW. Lastly, C_{c} was not constant because the permittivity of the SU-8 was frequency dependent.

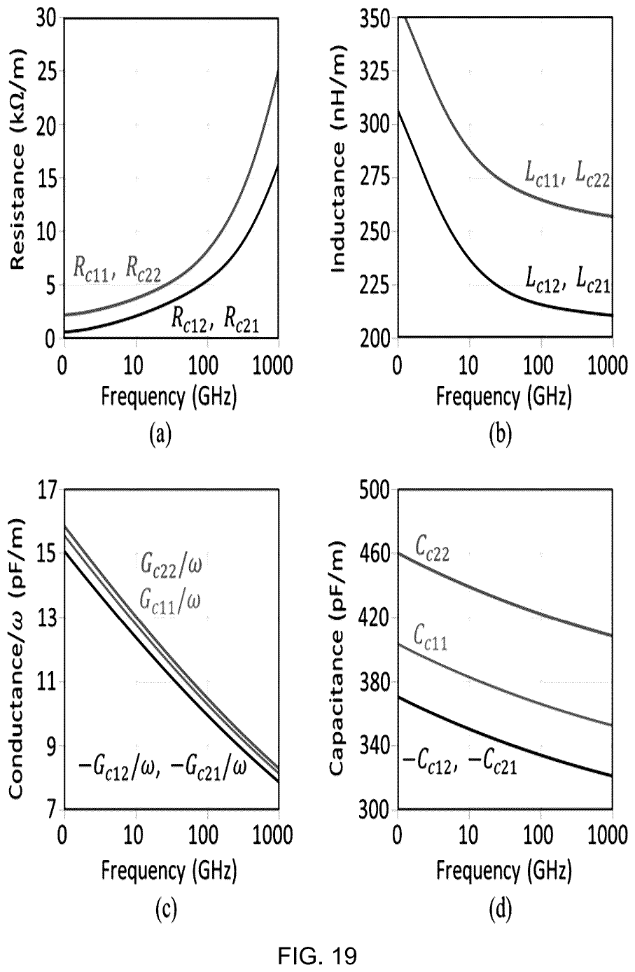

We used the simulated R_{c}, L_{c}, G_{c}, and C_{c} values to analytically model S. Our model accurately predicted the transmission (S₁₂) behavior for four values of l_{c} from dc to 1 THz (FIG. 19). Unlike our 3D simulations, our model does not account for fringing fields or radiation. We attribute the minor disagreement between our model and full-wave simulations at low frequencies to the simplifying assumption that all CPW ground planes are uniformly grounded. At higher frequencies, we attribute the disagreement in the position of the notch in transmission (FIG. 19(c), for example) to fringing field effects that increase the effective coupling length. Identical simulations with lossless materials—where radiation is the only loss mechanism—showed that radiation was negligible.

This Example describes a generalized theory for distributed contactless interconnects that does not require resource intensive 3D full-wave simulations. The theory was applied to broadside-coupled coplanar waveguides separated by an SU-8 dielectric layer. We validated the analytical theory against 3D full-wave simulations and showed that the contactless interconnects can transmit mmWave and terahertz signals with low insertion loss. Finally, we predict the performance of several designs for distributed contactless interconnects to 1 THz.

The processes described herein can be embodied in, and fully automated via, software code modules executed by a computing system that includes one or more general purpose computers or processors. The code modules can be stored in any type of non-transitory computer-readable medium or other computer storage device. Some or all the methods can alternatively be embodied in specialized computer hardware. In addition, the components referred to herein can be implemented in hardware, software, firmware, or a combination thereof.

Many other variations than those described herein can be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor can also include primarily analog components. For example, some or all of the signal processing algorithms described herein can be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions can be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It can also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

### PARTS LIST

dielectric-gapped electromagnetic conductive interconnect 200
primary communications member 201
secondary communications member 202
distributed wireless junction 203
primary wireless communicator 204
primary wired extension 205
primary signal line 206
primary ground line 207
secondary wireless communicator 208
secondary wired extension 209
secondary signal line 210
secondary ground line 211
interstitial dielectric partition 212
first transmission member 213
first transmission signal line 214
first transmission ground line 215
second transmission member 216
second transmission signal line 217
second transmission ground line 218
primary transceiver 219
secondary transceiver 220
primary interconnect signal 221
secondary interconnect signal 222
primary transmission signal 223
primary receive signal 224
first transmit transceiver signal 225
first receive transceiver signal 226
secondary transmission signal 227
secondary receive signal 228
second transmit transceiver signal 229
first receive transceiver signal 230
dielectric layer 231
junction length 232
junction cross-sectional area 233
electrically communicating an alternating current electrical signal/electrically communicates an alternating current electrical signal

What is claimed is:

1. A dielectric-gapped electromagnetic conductive interconnect (200) for electrically communicating an alternating current electrical signal, the dielectric-gapped electromagnetic conductive interconnect (200) comprising:
primary communications member (201) disposed on interstitial dielectric partition (212) and in electrical communication with secondary communications member (202) and that comprises primary wireless communicator (204), primary wired extension (205), and primary signal line (206), such that primary communications member (201) communicates primary interconnect signal (221) to secondary communications member (202), and primary communications member (201) receives secondary interconnect signal (222) from secondary communications member (202) and communicates secondary interconnect signal (222) as primary receive signal (224);
distributed wireless junction (203) that comprises primary communications member (201), secondary communications member (202), and interstitial dielectric partition (212), such that primary communications member (201) is spaced apart from secondary communications member (202) and electrically insulated from secondary communications member (202) by interstitial dielectric partition (212), secondary communications member (202) communicates secondary interconnect signal (222) to primary communications member (201), and secondary communications member (202) receives primary interconnect signal (221) from primary communications member (201), and comprises junction length (232) that tunes the frequency response of dielectric-gapped electromagnetic conductive interconnect (200) and junction cross-sectional area (233) that tunes the electromagnetic coupling of dielectric-gapped electromagnetic conductive interconnect (200) to primary transceiver (219) and secondary transceiver (220);
primary wireless communicator (204) disposed on primary wired extension (205) and interstitial dielectric partition (212) and in electromagnetic communication with secondary wireless communicator (208) and primary wired extension (205) and in mechanical communication with interstitial dielectric partition (212) and that comprises primary signal line (206);
primary wired extension (205) disposed on interstitial dielectric partition (212) and in electrical communication with primary wireless communicator (204) and in mechanical communication with interstitial dielectric partition (212) and that comprises primary signal line (206);
primary signal line (206) disposed on interstitial dielectric partition (212) and in electromagnetic communication with secondary signal line (210) and in mechanical communication with interstitial dielectric partition (212) and that extends from primary wireless communicator (204) to primary wired extension (205), such that primary signal line (206) in primary wireless communicator (204) receives secondary interconnect signal (222) from secondary signal line (210) in secondary wireless communicator (208) across interstitial dielectric partition (212), produces primary receive signal (224) from secondary interconnect signal (222) in primary wired extension (205), receives primary transmission signal (223) in primary wired extension (205), produces primary interconnect signal (221) from primary transmission signal (223) in primary wireless communicator (204), and communicates primary interconnect signal (221) to secondary signal line (210) in secondary wireless communicator (208) within distributed wireless junction (203);
secondary wireless communicator (208) disposed on secondary wired extension (209) and interstitial dielectric partition (212) and in electromagnetic communication with primary wireless communicator (204) and secondary wired extension (209) and in mechanical communication with interstitial dielectric partition (212) and that comprises secondary signal line (210);
secondary wired extension (209) disposed on interstitial dielectric partition (212) and in electrical communication with secondary wireless communicator (208) and in mechanical communication with interstitial dielectric partition (212) and that comprises secondary signal line (210);
secondary signal line (210) disposed on interstitial dielectric partition (212) and in electromagnetic communication with primary signal line (206) and in mechanical communication with interstitial dielectric partition (212) and that extends from secondary wireless communicator (208) to secondary wired extension (209), such that secondary signal line (210) in secondary wireless communicator (208) receives primary interconnect signal (221) from primary signal line (206) in primary wireless communicator (204) across interstitial dielectric partition (212), produces secondary receive signal (228) from primary interconnect signal (221) in secondary wired extension (209), receives secondary transmission signal (227) in primary wired extension (205), produces secondary interconnect signal (222) from secondary transmission signal (227) in secondary wireless communicator (208), and communicates secondary interconnect signal (222) to primary signal line (206) in primary wireless communicator (204) within distributed wireless junction (203); and
interstitial dielectric partition (212) on which is disposed primary communications member (201) and secondary communications member (202) and in mechanical communication with primary communications member (201) and in mechanical communication with secondary communications member (202) and that separates and electrically insulates primary communications member (201) from secondary communications member (202) in distributed wireless junction (203), such that interstitial dielectric partition (212) is interposed between primary communications member (201) and secondary communications member (202) in distributed wireless junction (203).

2. The dielectric-gapped electromagnetic conductive interconnect (200) of claim 1, further comprising primary ground line (207) disposed on interstitial dielectric partition (212) and in electromagnetic communication with primary signal line (206) and in mechanical communication with interstitial dielectric partition (212),
wherein primary wireless communicator (204) and primary wired extension (205) further comprise primary ground line (207), such that primary ground line (207) extends from primary wireless communicator (204) to primary wired extension (205) and provides an electrical ground reference for primary signal line (206).

3. The dielectric-gapped electromagnetic conductive interconnect (200) of claim 1, further comprising secondary ground line (211) disposed on interstitial dielectric partition (212) and in electromagnetic communication with secondary signal line (210) and in mechanical communication with interstitial dielectric partition (212),
wherein secondary wireless communicator (208) and secondary wired extension (209) further comprise secondary ground line (211), such that secondary ground line (211) extends from secondary wireless communicator (208) to secondary wired extension (209) and provides an electrical ground reference for secondary signal line (210).

4. The dielectric-gapped electromagnetic conductive interconnect (200) of claim 1, further comprising first transmission member (213) in electrical communication with primary communications member (201) and that receives first transmit transceiver signal (225), produces primary transmission signal (223) from first transmit transceiver signal (225), communicates primary transmission signal (223) to primary communications member (201), receives primary receive signal (224) from primary communications member (201), and produces first receive transceiver signal (226) from primary receive signal (224).

5. The dielectric-gapped electromagnetic conductive interconnect (200) of claim 4, further comprising:
first transmission signal line (214) disposed on first transmission member (213) and in electrical communication with primary signal line (206), wherein first transmission member (213) comprises first transmission signal line (214) and first transmission ground line (215), such that first transmission signal line (214) receives first transmit transceiver signal (225), produces primary transmission signal (223) from first transmit transceiver signal (225), communicates primary transmission signal (223) to primary signal line (206) of primary communications member (201) in primary wired extension (205), receives primary receive signal (224) from primary signal line (206) in primary wired extension (205), and produces first receive transceiver signal (226) from primary receive signal (224); and
first transmission ground line (215) disposed on first transmission member (213) and in electromagnetic communication with first transmission signal line (214) and that provides an electrical ground reference for first transmission signal line (214).

6. The dielectric-gapped electromagnetic conductive interconnect (200) of claim 1, further comprising second transmission member (216) in electrical communication with secondary communications member (202) and that receives second transmit transceiver signal (229), produces secondary transmission signal (227) from second transmit transceiver signal (229), communicates secondary transmission signal (227) to secondary communications member (202), receives secondary receive signal (228) from secondary communications member (202), and produces first receive transceiver signal (230) from secondary receive signal (228).

7. The dielectric-gapped electromagnetic conductive interconnect (200) of claim 6, further comprising:
second transmission signal line (217) disposed on second transmission member (216) and in electrical communication with secondary signal line (210), wherein second transmission member (216) comprises second transmission signal line (217) and second transmission ground line (218), such that second transmission signal line (217) receives second transmit transceiver signal (229), produces secondary transmission signal (227) from second transmit transceiver signal (229), communicates secondary transmission signal (227) to secondary signal line (210) of secondary communications member (202) in secondary wired extension (209), receives secondary receive signal (228) from secondary signal line (210) in secondary wired extension (209), and produces first receive transceiver signal (230) from secondary receive signal (228); and
second transmission ground line (218) disposed on second transmission member (216) and in electromagnetic communication with second transmission signal line (217) and that provides an electrical ground reference for second transmission signal line (217).

8. The dielectric-gapped electromagnetic conductive interconnect (200) of claim 4, further comprising primary transceiver (219) in electromagnetic communication with first transmission member (213) and that produces first transmit transceiver signal (225) and communicates first transmit transceiver signal (225) to first transmission member (213) and receives first receive transceiver signal (226) from first transmission member (213).

9. The dielectric-gapped electromagnetic conductive interconnect (200) of claim 6, further comprising secondary transceiver (220) in electromagnetic communication with second transmission member (216) and that produces second transmit transceiver signal (229) and communicates second transmit transceiver signal (229) to second transmission member (216) and receives first receive transceiver signal (230) from second transmission member (216).

10. The dielectric-gapped electromagnetic conductive interconnect (200) of claim 1, further comprising dielectric layer (231) disposed on primary communications member (201) and secondary communications member (202) and that electrically insulates primary communications member (201) and secondary communications member (202).

11. A process for electrically communicating an alternating current electrical signal with a dielectric-gapped electromagnetic conductive interconnect, the process comprising:
disposing a primary communications member on an interstitial dielectric partition;
disposing a secondary communications member on the interstitial dielectric partition;
electrically connecting the primary communications member to the secondary communications member;
communicating an alternating current electrical signal between the primary communications member and the secondary communications member; and
receiving the alternating current electrical signal at the secondary communications member.

12. The process of claim 11, wherein the primary communications member comprises a primary wireless communicator, a primary wired extension, and a primary signal line.

13. The process of claim 12, wherein the secondary communications member comprises a secondary wireless communicator, a secondary wired extension, and a secondary signal line.

14. The process of claim 13, wherein the primary signal line is disposed on the interstitial dielectric partition and in electromagnetic communication with the secondary signal line.

15. The process of claim 14, wherein the primary signal line in the primary wireless communicator receives a secondary interconnect signal from the secondary signal line in the secondary wireless communicator across the interstitial dielectric partition.

16. The process of claim 15, wherein the primary signal line in the primary wireless communicator produces a primary receive signal from the secondary interconnect signal.

17. The process of claim 16, wherein the primary signal line in the primary wireless communicator receives a primary transmission signal.

18. The process of claim 17, wherein the primary signal line in the primary wireless communicator produces a primary interconnect signal from the primary transmission signal.

19. The process of claim 18, wherein the primary interconnect signal is communicated to the secondary signal line in the secondary wireless communicator.

20. The process of claim 19, wherein the secondary signal line in the secondary wireless communicator receives the primary interconnect signal from the primary signal line in the primary wireless communicator across the interstitial dielectric partition.

21. The process of claim 20, wherein the secondary signal line in the secondary wireless communicator produces a secondary receive signal from the primary interconnect signal.

22. The process of claim 21, wherein the secondary signal line in the secondary wireless communicator receives a secondary transmission signal.

23. The process of claim 22, wherein the secondary signal line in the secondary wireless communicator produces a secondary interconnect signal from the secondary transmission signal.

24. The process of claim 23, wherein the secondary interconnect signal is communicated to the primary signal line in the primary wireless communicator.

25. The process of claim 24, wherein the primary signal line in the primary wireless communicator receives the secondary interconnect signal from the secondary signal line in the secondary wireless communicator across the interstitial dielectric partition.
